(19) United States
(12) Patent Application Publication
(10) Pub. No.: US 2026/0201085 A1
(43) Pub. Date: Jul. 16, 2026

(54) METHOD OF SYNTHESIZING POLAR WAXES AND POLYKETONES

(71) Applicants: The Regents of the University of California, Oakland, CA (US); Mitsubishi Chemical Corporation, Tokyo (JP)

(72) Inventors: Hyunjin Moon, Goleta, CA (US); Costanza Leonardi, Santa Barbara, CA (US); Fumihiko Shimizu, Yarimizu, Hachioji (JP); Kazuki Fukumoto, Tokyo (JP); Susannah L. Scott, Goleta, CA (US)

(73) Assignees: The Regents of the University of California, Oakland, CA (US); Mitsubishi Chemical Corporation, Tokyo (JP)

(21) Appl. No.: 19/135,558

(22) PCT Filed: Dec. 15, 2023
(86) PCT No.: PCT/US2023/084415

§ 371 Date: Jun. 4, 2025

Related U.S. Application Data
(60) Provisional application No. 63/433,849, filed on Dec. 20, 2022.

(51) Int. Cl. C08F 16/36; C08F 10/00

(52) U.S. Cl. CPC C08F 16/36; C08F 10/00

(57) ABSTRACT

A method of producing an oxidized form of waxes (polar waxes) or polyketones containing oxygen functional groups, which can be used as lubricants, adhesives, coating reagents, etc., from polypropylene (PP), polystyrene (PS) and/or polyethylene (PE). In one or more examples, a hydroperoxide was used as the oxidant to cleave C—C and C—H bonds at a mild temperature (e.g., 150° C.). C—C bond cleavage leads to a decrease in the number-averaged molecular weights (Mₙ) of polypropylene and polyethylene to 500-5000 g/mol. The method was successfully applied to the conversion of post-consumer polyolefin waste to make polar waxes or polyketones.

### CROSS REFERENCE TO RELATED APPLICATIONS

This application claims the benefit under 35 U.S.C. Section 119(e) of co-pending and commonly assigned U.S. Provisional Application Ser. No. 63/433,849, filed Dec. 20, 2022, by Hyunjin Moon, Fumihiko Shimizu, Kazuki Fukumoto, and Susannah L. Scott, entitled “METHOD OF SYNTHESIZING POLAR WAXES,” which application is incorporated by reference herein.

### BACKGROUND OF THE INVENTION

### 1. Field of the Invention

The present disclosure relates to methods of synthesizing polar waxes (e.g., containing carbonyl groups) and polyketones from polyolefins, e.g., via an oxidative cleavage of the polyolefin.

### 2. Description of the Related Art

Polyolefins are indispensable in our everyday life by virtue of their excellent chemical stability, and physical properties that can be controlled to suit various applications, via inexpensive manufacturing methods. However, consumer use of single-use plastics leads to undesirable plastic waste that is relatively non-biodegradable. In order to reduce the environmental impact of this waste, the plastic can be recovered for mechanical recycling, but this process results in reduced thermal and mechanical robustness of the recycled plastic and only delays the timing of land-filling for the non-biodegradable plastic waste. This downside limits the application scopes for recycled plastics, reducing the incentive for this kind of recycling. What is needed then, is a plastic upcycling technology that converts discarded plastics into value-added products that, furthermore, decompose relatively rapidly under natural conditions. The present disclosure simultaneously satisfies both needs.

### SUMMARY OF THE INVENTION

The invention presents the method of producing an oxidized form of waxes by converting polypropylene (PP), polystyrene (PS), or polyethylene (PE). This process is conducted at a mild reaction temperature (e.g., 150° C.) using a peroxide (e.g., tert-butyl hydroperoxide (TBHP)) solution in a closed reactor filled with either air or inert gas. The presence of oxygen-containing functional groups such as carbonyls, acids, esters, and alcohols in the oxidized product was confirmed by infrared (IR) and nuclear magnetic resonance (NMR) spectroscopies as well as elemental analysis and titration. The oxidized waxes afford various functionalities by blending with, or in combination with, other types of materials and/or further converting the oxygen-containing groups to other functional groups. For example, the oxidized waxes, which are more polar than hydrophobic waxes, can be used as additives added to or mixed with polar materials to obtain compositions with new properties (e.g., mechanical properties).

Illustrative embodiments of the present invention include, but are not limited to, the following.

1. A method of synthesizing a wax or a polyketone, comprising;
reacting of a polyolefin with a peroxide in a presence of a solvent under conditions including a temperature below 200° C., wherein at least one of carbon-carbon bonds or carbon-hydrogen bonds in the polyolefin are cleaved via oxidation by the peroxide so as to form a polyketone or a wax comprising an oxidized polyolefin.

2. The method of embodiment 1, further comprising catalyzing the reaction using a catalyst decomposing the peroxide so that oxygen from the peroxide can react more readily with the polyolefin.

3. The method of embodiment 1, further comprising catalyzing the reaction using [Fe(III)SO₄] or MnBr₂.

4. The method of embodiment 2 or 3, wherein the peroxide is hydrogen peroxide, the solvent is water, and the reaction forms the polyketone.

5 The method of claim 2 or 3, wherein the peroxide is TBHP, the solvent is water, and the reaction forms the wax.

6. The method of embodiment 5, wherein wax has a molecular weight of 500 or less or 1000 or less.

7 The method of embodiment 1, further comprising controlling at least one of a composition of the peroxide, the temperature, and a duration of the reaction to select the wax or the polyketone.

8. The method of embodiment 1, wherein the peroxide comprises a hydroperoxide and the polyolefin comprises at least one of polyethylene, polystyrene, or polypropylene.

9. The method of embodiment 1 or 8, further comprising selecting a weight percentage of the peroxide in the solution relative to a mass of the polyolefin so as to achieve a desired molecular weight of the oxidized polyolefin, wherein a lesser weight percentage of the peroxide results in a higher molecular weight of the oxidized polyolefin.

10. The method of any of the embodiments 1-9, comprising:
10 wt %-200 wt % of the peroxide in the solution, relative to a mass of the polyolefin in the solution, or
contacting the peroxide with the polyolefin with a mole ratio, comprising a number of moles of the monomer unit (in the polyolefin) divided by the number of moles of the peroxide, in a range from ca. 0.5 to ca. 20.

11. The method of any of the embodiments 1 or 7-10, wherein the solvent comprises any hydrocarbon-based solvent capable of at least partially dissolving the polyolefin.

12. The method of embodiment 1, wherein the peroxide comprises a hydroperoxide, the solvent comprises water, and the polyolefin comprises polyethylene.

13. The method of any of the embodiments 1 or 7-12, wherein the oxidized polyolefin comprises a carbonyl.

14. The method of any of the embodiments 1 or 7-13, wherein the oxidized polyolefin comprises a ketone oxygen content greater than its ester and a carboxylic acid oxygen content.

15. The method of any of the embodiments 1 or 7-14, wherein an amount of the peroxide and a reaction time of the reaction are selected so that the one or more waxes have a number average molecular weight (Mₙ) in a range of 500-5000 g/mol with a dispersity in a range of 1.2-2.5.

16. The method of any of the embodiments 1 or 7-15, wherein the temperature is above 100° C. and below 200° C.

17. One or more waxes synthesized by the method of any of the embodiments 1-3 or 5-16.

18. The method of any of the claims 1-17, further comprising contacting untreated plastic waste, comprising at least the polyolefin (and e.g., optionally at least one of any additive, impurity, or other polyolefin) with the solvent.

19. A composition of matter, comprising an oxidized polyolefin having at least one of:
a number-averaged molecular weight in a range of 500-5000 g/mol and optionally a dispersity index in a range of 1.2 to 2.5;
an oxygen content characterized by a saponification number in a range of 30-200 (30≤saponification number≤200) or 30≤(30≤saponification number≤150), wherein the saponification is the amount of potassium hydroxide in milligrams required to saponify one gram of the oxidized polyolefin,
the oxygen content characterized by an acid number in a range of 15-100, wherein the acid number is the amount of potassium hydroxide in milligrams required to neutralize 1 g of oxidized polyolefin dissolved in xylene,
an oxygen content of 3-15 wt. % (e.g., 3 wt. %≤oxygen content≤15 wt %) relative to the mass of the oxidized polyolefin,
a ketone oxygen content, which is greater than the ester and carboxylic acid oxygen content; or
an alcohol oxygen content, which is ca. 1-4 wt %.

20. The composition of matter of embodiment 19, wherein the oxidized polyolefin has a melting point in a range of 70-120° C.

21. The composition of matter of embodiment 19 or 20, wherein the oxidized polyolefin is characterized by the saponification number comparable to or greater than that for the oxidized polyolefin formed by oxidation of a molten polyolefin by melt oxidation, oxidation of the polyolefin in an aqueous dispersion, or oxidation of the polyolefin in a solid form.

22. The composition of matter of any of the claims 19-21, wherein the oxidized polyolefin comprises oxidized polypropylene, oxidized polyethylene, or oxidized polystyrene.

23. A lubricant, adhesive, or coating comprising the wax of any of the claims 19-22.

24. The composition of matter of any of the embodiments 19-23, wherein the oxidized polyolefin comprises the structure:

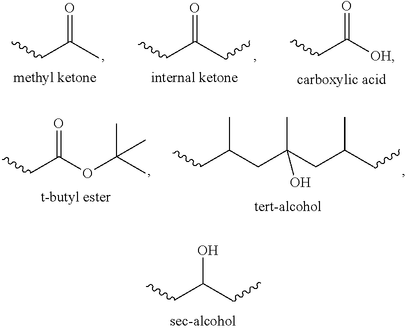

25. The composition of matter of any of the embodiments 19-24 synthesized using the method of any of the claim 1-3 or 6-18 wherein the polyolefin comprises at least one of polypropylene, polyethylene or polystyrene.

26. A precursor from which oxidized polyolefin may be synthesized, comprising:

untreated plastic waste comprising a polyolefin and a solution comprising peroxide and the polyolefin at least partially dissolved in a solvent.

27. A mixture comprising the precursor of embodiment 26 and oxidized polyolefin formed by oxidation of the polyolefin by the peroxide.

28. A polyketone comprising an oxygen content larger than 4 wt %; wherein a content of ketones is greater than a content of the esters.

29. The polyketone of embodiment 28 synthesized by the method of any of the claims 1-4 wherein the polyolefin comprises LDPE.

30. The polyketone of any of the embodiments 28-29 of the structure:

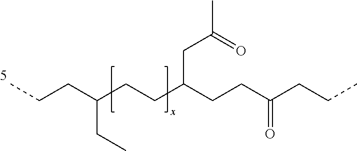

31. A reactor for synthesizing oxidized polyolefin from plastic waste, comprising:
a vessel for containing a solution comprising peroxide and the polyolefin;
a temperature sensor coupled to the pressure vessel for regulating a temperature of the solution;
one or more openings in the pressure vessel for transferring at least one of the solution or the solvent into the pressure vessel;
a control circuit for controlling the temperature and reaction time of an oxidation reaction wherein carbon-carbon bonds and/or carbon-hydrogen in the polyolefin are cleaved via oxidation by the peroxide so as to form a polyketone or one or more waxes comprising an oxidized polyolefin; and
an opening for removing the oxidized polyolefin from the pressure vessel.

32. The method or composition of matter of any of the embodiments, wherein the oxidized polyolefin has a molecular weight no greater than 2000 g/mol.

33. The method of any of the embodiments 1-32, wherein the solvent increases a rate of the oxidation reaction by at least:
completely or partially dissolving the polyolefin prior to or after the oxidation is initiated, or
swelling and/or softening the polyolefin prior to or after the oxidation is initiated.

34. The method of any of the embodiments 1-33, wherein the solvent dissolves the peroxide.

35. The method of any of the embodiments 1-34, wherein the solvent at least increases a rate of the oxidation or lowers a temperature at which the oxidation takes place.

### BRIEF DESCRIPTION OF THE DRAWINGS

Referring now to the drawings in which like reference numbers represent corresponding parts throughout:

FIG. 1. (a) Molecular weight distribution of iPP (green) and oxidized iPP obtained after reaction at 150° C. with 1.0 mL TBHP solution (5.5 M in n-decane): for one 24 h period (purple) and for two 24 h periods (blue). 0.4 g iPP (Mₙ 54,000 g/mol, M_{w}=340,000 g/mol) was used. (b) Molecular weight distribution of various PPs before (solid lines) and after (dotted lines) oxidation reaction. Reaction conditions: PP 0.4 g, TBHP (5.5 M, decane) 1.0 mL, 150° C., 24 h.

FIG. 2. Molecular weight distribution of oxidized PP (red) obtained from the mixture of iPP and aPP. Reaction conditions: low MW (molecular weight) iPP, high MW iPP, aPP 0.133 g each, TBHP (5.5 M in decane) 1.0 mL, 150° C., 24 h.

FIG. 3. (a) Evolution of molecular weight (Mₙ) and (b) polydispersity (Ð) with time for a high/low MW iPP. Reaction conditions: iPP 0.4 g, TBHP (5.5 M in decane) 1.0 mL, 150° C.

FIG. 4. IR spectra of iPP (0.400 g, Mₙ 54,000 g/mol, Ð=6.5): (a) before, and (b-d) after 24 h reaction at 150° C. Reaction conditions: (b) TBHP (1.0 mL, 5.5 M in n-decane), in air; (c) TBHP (1.0 mL, 5.5 M in n-decane) in N₂, and (d) n-decane (1.0 mL) in air.

FIG. 5. (a) IR spectra of oxi-iPP1 and oxi-iPP2. (b) Magnified region showing different carbonyl groups.

FIG. 6. Solution-state (a) ¹H and (b) ¹³C NMR spectra of oxidized iPP. Reaction conditions: iPP (Mₙ 54,000, Ð=6.5) 0.4 g, TBHP (5.5 M in decane) 1.0 mL, 150° C., 24 h.

FIG. 7. ¹H-¹³C 2D HSQC NMR of oxi-iPP1. Reaction conditions: iPP (Mₙ 54,000 and M_{w} 350,000 g/mol) 0.4 g, TBHP (5.5 M in decane) 1.0 mL, 150° C., 24 h.

FIG. 8. ¹H-¹³C 2D HMBC NMR spectrum of oxi-iPP1. The peak marked with a red circle indicates the correlation between methyl protons and the carbon of a tertiary alcohol, as shown in the chemical structure. Reaction conditions: iPP (Mₙ 54,000, M_{w} 350,000 g/mol) 0.4 g, TBHP (5.5 M in decane) 1.0 mL at 150° C. for 24 h.

FIG. 9. Effect of TBHP: PP ratio on IR spectra of PP and oxi-PP, for: (a) low MW iPP (Mₙ 8,300 g/mol, Ð 2.8), (b) high MW iPP (Mₙ 54,000 g/mol, Ð 6.5), and (c) aPP (Mₙ 6,700 g/mole, Ð 4.1).

FIG. 10. Effect of TBHP: PP ratio on GPC analysis of various PPs and oxi-PP.

FIG. 11. IR spectra of oxidized post-consumer PPs. Reaction conditions: Post-consumer PP 0.4 g, TBHP (5.5 M in decane) 1.0 mL, 150° C., 24 h.

FIG. 12. (a) Information on the molecular weights of post-consumer PPs before and after oxidation. (b) Changes in the molecular weight distributions before and after oxidation of post-consumer PPs. Reaction conditions: post-consumer PP 0.4 g, TBHP (5.5 M in decane) 1.0 mL, 150° C., 24 h. (c) Formation of methyl ketone, alcohol ester, ester, perester from oxidation of PP.

FIG. 13. (a) Molecular weight distributions, and (b) IR spectroscopic characterization, for various PEs and their oxidized products. (c) Magnified region showing OH stretching of alcohol. The IR spectra of oxi-PEs show ketone stretching at 1712 cm-1. Reaction conditions: PE 0.27 g, TBHP (5.5 M, decane) 1.0 mL, 150° C., 24 h.

FIG. 14. IR spectra of various grades of PE and their oxidized products, magnified in the region 1800-1600 cm⁻¹, for oxi-LDPE1, oxi-HDPE1, and oxi-UHMWPE. Reaction conditions: PE 0.267 g, TBHP 1.0 mL, 150° C., 24 h

FIG. 15. IR spectra of oxidized (a) HDPE and (b) LDPE (reaction conditions: PE 0.267 g, TBHP 1.0 mL, 150° C., 24 h. Oxi-HDPE2 and oxi-LDPE2 were obtained by additional TBHP oxidation.

FIG. 16. Molecular weight distributions of oxidized (a) HDPE and (b) LDPE (reaction conditions: PE 0.267 g, TBHP 1.0 mL, 150° C., 24 h. Oxi-HDPE2 and oxi-LDPE2 were obtained by additional TBHP oxidation.

FIG. 17. ¹H-¹³C 2D HSQC NMR of oxidized HDPE. Reaction conditions: HDPE 0.267 g (Mₙ 18,000 g/mol, Ð=16), TBHP (5.5 M in decane) 1.0 mL, 150° C., 24 h.

FIG. 18. ¹H-¹³C 2D HSQC NMR of oxidized (a) HDPE and (b) LDPE. The correlation between the methine proton and secondary carbon of the alcohol is marked with the red circle. Reaction conditions: HDPE (or LDPE) 0.267 g, TBHP (5.5 M in decane) 1.0 mL, 150° C., 24 h.

FIG. 19. a. IR spectra of PE oxidized by H₂O₂ solution at various temperatures. Reaction conditions: PE (Mₙ 1740 g/mol, D 2.5) 0.267 g, H₂O₂ (30 wt % in H₂O) 1.0 mL, 24 h. b. Formation of internal ketone, alcohol, carboxylic acid, and ester chain ends from oxidation of PE.

FIG. 20. (a) GPC results for polystyrene (PS) and oxidized PS products. (b) IR spectra of PS and oxidized PS. The shaded region at ca. 1700 cm⁻¹ indicates the formation of carbonyl groups (carboxylic acid, phenyl ketone, etc). The broad peak at 3400 cm⁻¹ indicates the formation of alcohol groups on the chain. Reaction conditions: PS (Mₙ 112,000 g/mol, Ð 2.3) 0.40-0.99 g, TBHP (5.5 M in n-decane) 1.0 mL, 150° C., 24 h.

FIG. 21. Characterization of oxi-PP/PE by (a) IR, and (b) GPC. GPC analysis of the starting polymers is shown as well. Reaction conditions: 0.100 g each of high and low molecular weight iPP, LDPE, and HDPE (total 0.400 g), TBHP (5.5 M in decane) 1.5 mL, 150° C., 24 h.

FIG. 22. (a) HDPE/iPP (white HDPE and green iPP bottles, with labels), tested in oxidative cleavage to polar waxes. Molecular weights before (black) and after (blue) oxidation reactions are shown. (b) IR Characterization of oxi-PP/PE obtained from the mixture of post-consumer HDPE and PP.

FIG. 23. General reaction scheme for the selective catalytic oxidation of LDPE.

FIG. 24a. IR spectrum of oxi-LDPE. Reaction conditions: 0.05 g LDPE (M_{w} 56,000, Ð 6.1), 1 mL tBuOOH (70 wt % in H₂O), 2.5 wt % MnBr₂ at 110° C. for 24 h.

FIG. 24b. Deconvolution of C—O stretching (carbonyl) peak centered at 1716 cm⁻¹. IR spectrum of oxi-LDPE. Reaction conditions: 0.05 g LDPE (M_{w} 56,000, Ð 6.1), 1 mL tBuOOH (70 wt % in H₂O), 2.5 wt % MnBr₂ at 110° C. for 24 h.

FIG. 25. (a) Evolution of molecular weight (MW) with time for oxi-LDPE, obtained by GPC analysis; (b) IR spectra showing the evolution of carbonyl peak intensity over time. Reaction conditions: 0.05 g LDPE (M_{w} 56,000, Ð 6.1), 1 mL tBuOOH (70 wt % in H₂O), 2.5 wt % MnBr₂ at 110° C. for 24 h.

FIG. 26. (a) IR spectra showing the evolution of carbonyl peak intensity over time for oxi-LDPE; (b) Evolution of M_{w} with time, according to GPC. Reaction conditions: 0.05 g LDPE (M_{w} 56,000, Ð 6.1), 1 mL H₂O₂ (30 wt % in H₂O), 2.5 wt % MnBr₂ at 110° C. for 15-24 h.

FIG. 27. Solution-state NMR spectrum of oxidized LDPE: (a) ¹H NMR, and (b) 2D ¹H-¹³C HSQC NMR. Reaction conditions: 0.05 g LDPE (M_{w} 56,000, Ð 6.1), 1 mL H₂O₂ (30 wt % in H₂O), 2.5 wt % MnBr₂ at 110° C. for 15-24 h.

FIG. 28. IR spectra of LDPE (green) and oxi-LDPEs made by oxidation with TBHP (light blue) or H₂O₂ (dark blue). Reaction conditions: 0.05 g LDPE (M_{w} 56,000, Ð 6.1), oxidant (1 mL H₂O₂ 30 wt % in H₂O or 1 mL TBHP 70 wt % H₂O), 2.5 wt % MnBr₂ at 110° C. for 24 h.

FIG. 29. GPC of oxi-LDPE made by oxidation of LDPE with TBHP (light blue) or H₂O₂ (dark blue).

FIG. 30. Comparison of IR spectra of oxi-LDPE, obtained with various catalysts: (a) Anion effect: MnBr. (light blue), Mₙ (NO₃)₂ (grey blue), and without catalyst (green). (b) Cation effect: MnBr. (light blue), KBr (green) and without catalyst (purple). Reaction conditions: 0.05 g LDPE (M_{w} 56,000, Ð 6.1), oxidant (1 mL H₂O₂ 30 wt % in H₂O or 1 mL TBHP 70 wt % H₂O), 2.5 wt % catalyst at 110° C. for 24 h.

FIG. 31. Proposed mechanism for the oxidation of LDPE. FIG. 32a. Comparison of IR spectra of oxi-LDPE made by oxidation with excess H₂O₂ (red) or oxi-substoichiometric H₂O₂ (orange). Reaction conditions: 0.05 g LDPE (M_{w} 56,000, Ð 6.1), oxidant (1 mL H₂O₂ 30 wt % in H₂O), 2.5 wt % MnBr₂ at 110° C. for 24 h. Excess amount of H₂O₂: 5.5 equivalents of H₂O₂ (9.8 mmol, 1 mL of H₂O₂ 30 wt % in H₂O) to 1 equivalent of LDPE (1.8 mmol, 50 mg). Substoichiometric amount of H₂O₂: 0.5 equivalents of H₂O₂ (0.75 mmol, 0.08 mL of H₂O_{2 30} wt % in H₂O) to 1 equivalent of LDPE (1.8 mmol, 50 mg)

FIG. 32b. IR spectra of oxi-LDPEs. Reaction conditions: 0.05 g LDPE (M_{w} 56,000, Ð 6.1), 1 mL tBuOOH (70 wt % in H₂O), 2.5 wt % MnBr₂ at 110° C. for 8 h (orange spectrum); 0.05 g LDPE (M_{w} 56,000, Ð 6.1), 1 mL H₂O₂ (30 wt % in H₂O), 2.5 wt % MnBr₂ at 110° C. for 24 h (blue spectrum).

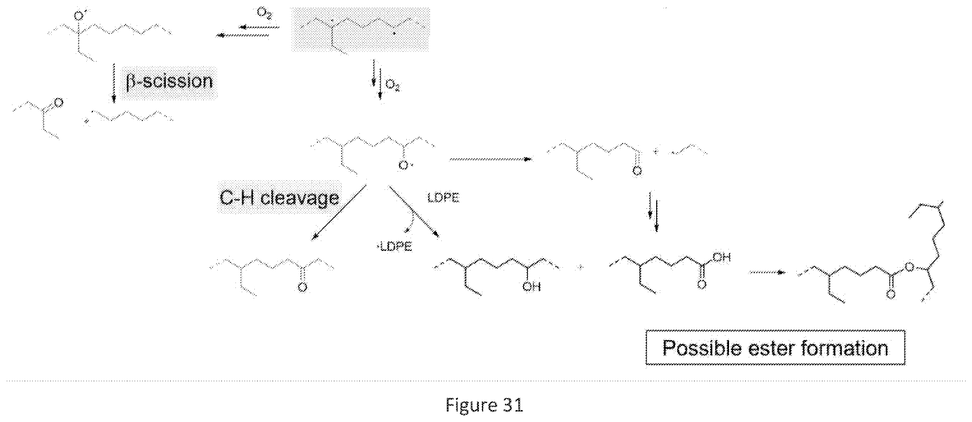

FIG. 31c. Molecular weight (M_{w}) of oxi-LDPEs, obtained by GPC analysis. Reaction conditions: 0.05 g LDPE (M_{w} 56,000, Ð 6.1), 1 mL tBuOOH (70 wt % in H₂O), 2.5 wt % MnBr₂ at 110° C. for 8 h (blue line); 0.05 g LDPE (M_{w} 56,000, Ð 6.1), 1 mL H₂O₂ (30 wt % in H₂O), 2.5 wt % MnBr₂ at 110° C. for 24 h (green line).

FIG. 33. (a) IR spectroscopic characterization of LDPE (blue), and oxi-LDPE (orange) prepared by reaction of LDPE with TBHP at 100° C. for 24 h catalyzed by FeSO₄ in isooctane (0.5 mL). Theketone stretching mode appears at 1714 cm⁻¹. (b) GPC analysis of the CHCl₃-soluble fraction of oxi-LDPE.

FIG. 34. IR spectroscopic characterization of LDPE (green), oxi-LDPE (a) prepared by reaction of LDPE (0.05 g) at 110° C. for 24 h with TBHP (1 mL, 70 wt % in H₂O)+MnBr₂ (2.5 wt %) and oxi-LDPE (b) prepared by reaction of LDPE (0.05 g) at 110° C. for 24 h with H₂O₂ (0.5 mL, 30 wt % in H₂O)+MnBr₂ (2.5 wt %). The ketone stretching mode appears at 1714 cm⁻¹.

FIG. 35. Solution-state NMR spectrum of oxidized LDPE: 1D ¹H NMR in CDCl₃. Reaction conditions: LDPE (0.05g) reacting at 110° C. for 24 h with TBHP (1 mL, 70 wt % in H₂O)+MnBr₂ (2.5 wt %).

FIG. 36. Solution-state NMR spectrum of oxidized LDPE: 2D ¹H-¹³C HSQC NMR in CDCl₃. Reaction conditions: LDPE (0.05g) reacting at 110° C. for 24 h with TBHP (1 mL, 70 wt % in H₂O)+MnBr₂ (2.5 wt %).

FIG. 37. Comparison of IR spectra for LDPE before (blue) and after (orange) oxidation by LDPE (0.05 g) with a solution of Ti (OPrⁱ) 4 (10 wt %) and TBHP (1 mL, 5.5 M in n-decane) for 24 h at 100° C.

FIG. 38. Comparison of IR spectra for oxi-LDPE prepared with Ti-sylopol heterogeneous catalystand H₂O₂ (orange), in comparison with oxi-LDPE obtained with Ti(OPrⁱ) 4 and TBHP (blue).

FIG. 39. Reported⁴ thermal oxidation of PE with O₂ in scCO₂.

FIG. 40. Comparison of the IR of oxi-LDPE (orange) obtained by reaction with H₂O₂ in scCO₂.

FIG. 41. Flowchart illustrating a method of synthesizing a wax or polyketone.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

The present disclosure describes a method of synthesizing a wax, comprising making a solution comprising peroxide and a polyolefin at least partially dissolved in a solvent; and initiating a reaction of the polyolefin with the peroxide, under conditions including a temperature below 200° C., wherein carbon-carbon bonds in the polyolefin are cleaved via oxidation by the peroxide so as to form one or more waxes comprising an oxidized and cleaved polyolefin. The following sections describe various embodiments of the method.

### First Example: PP Depolymerization Via an Oxidative Cleavage Reaction

The first example demonstrates a new approach to the oxidative cleavage of various PPs under catalyst-free reaction conditions using tert-butyl hydroperoxide (TBHP) as the oxidant. The TBHP solution (5.5 M in n-decane) is capable of dissolving the isotactic PP (iPP) starting material at 150° C.

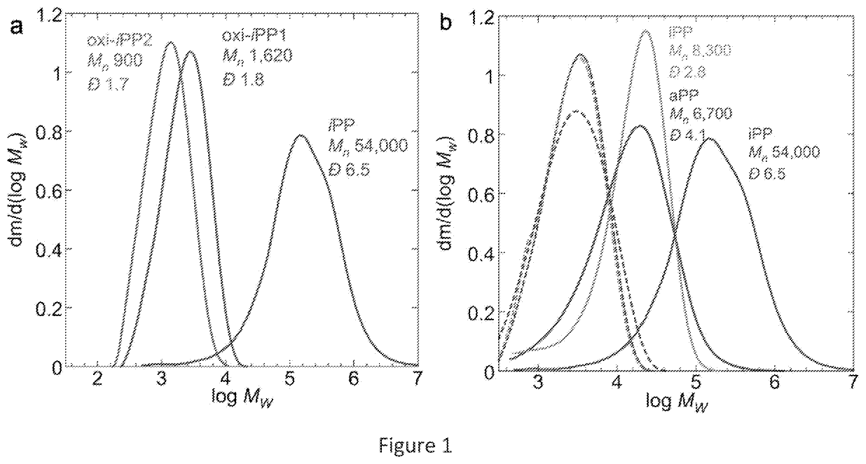

The GPC analysis for the oxi-iPP product obtained by TBHP-mediated oxidation shows that the oxidation reaction causes both the number-averaged (Mₙ) and weight-averaged (M_{w}) molecular weights of iPP to decrease dramatically, from Mₙ 54,000 (Ð=6.5) to Mₙ 1,620 g/mol (Ð=1.8) (FIG. 1a), indicating that the TBHP cleaves the C—C bonds of iPP. To further reduce the molecular weight, the oxi-iPP1 recovered after reaction at 150° C. for 24 h was heated at 70° C. overnight in a furnace to remove volatiles (unreacted TBHP, decane, t-butanol and decane oxygenates). After a second reaction at 150° C. for 24 h with the same amount of TBHP, the molecular weight decreased from Mₙ 1,620 g/mol (Ð=1.8) for oxi-iPP1 to Mₙ 900 g/mol (Ð=1.7) for oxi-iPP2 (FIG. 1a).

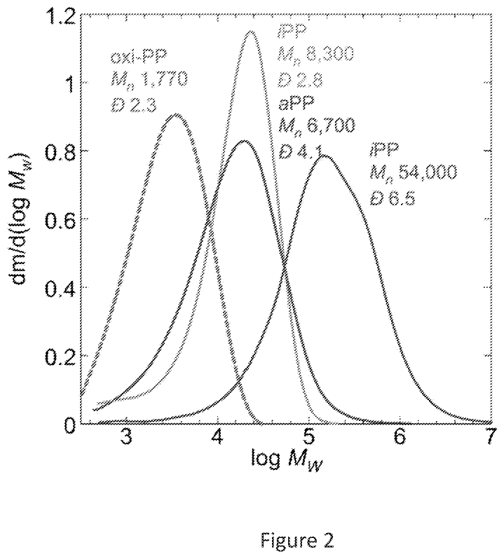

The same reaction was conducted for low/high MW iPP and atactic PP. As shown in the molecular weight distributions in FIG. 1b, the oxidized PPs showed similar Mₙ values regardless of their initial molecular weight, dispersity, and tacticity. This result indicates that more C—C bond cleavage events occur in longer chains, while fewer C—C bond cleavage events occur in shorter chains. Thus, this result suggests that the TBHP-mediated PP oxidation is beneficial in processing waste PPs because the oxidation reaction results in oxidized products with similar molecular weights as shown in FIG. 2.

The following sections describe various characterizations of the waxes formed according to the first example.

1. The Molecular Weight of the Wax Product Decreases with Increasing Reaction Time.

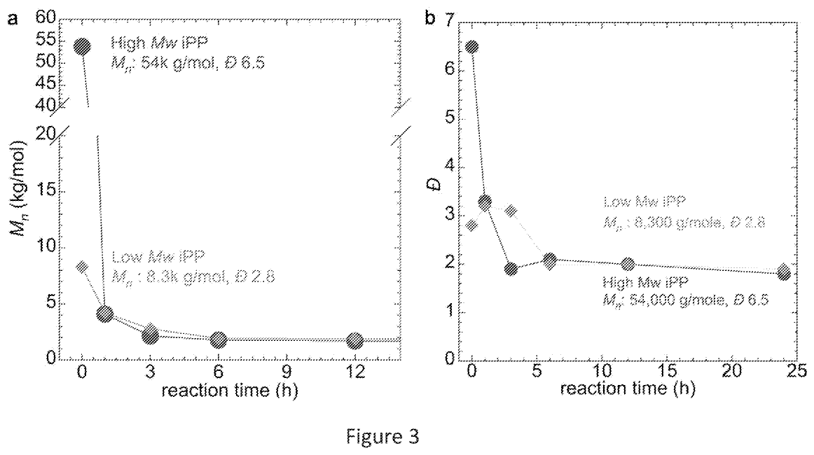

Random chain cleavage should result in a rapid decreases in the average chain length initially, followed by progressively smaller decreases as the number of chains increases. The observed initial decrease in Mₙ is abrupt, from 54,000 to ca. 4,000 g/mol within the first 1 h, then much more gradual to ca. 1,600 g/mol after 24 h (FIG. 3a). The gradual decrease is attributed to a slower rate of TBHP consumption for iPP oxidation (0.92 mmol/h before 1 h vs. 0.02 mmol/h between 3-6 h). Thus, most of the oxidation reaction was completed within 6 h.

### 2. Identity of the Oxidant

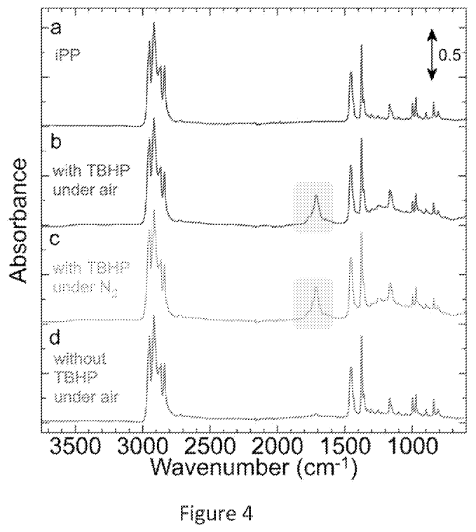

IR spectra of iPP and oxi-iPP1 are compared in FIG. 4. In the spectrum of oxi-iPP, an intense new peak with a maximum at 1714 cm⁻¹ is characteristic of carbonyl groups (FIG. 4b). The broad peak of oxi-iPP1 around 3400 cm⁻¹ indicates the formation of alcohol. Control experiments were conducted under N₂ with TBHP, and in air without using TBHP to identify the oxidant. The products produced by TBHP under N₂ do have an intense peak at 1712 cm⁻¹ (FIG. 4c). In contrast, the IR spectrum of the product obtained without using TBHP shows a negligible peak at ca. 1712 cm⁻¹ (FIG. 4d). Thus, exclusively TBHP, not air, is responsible for the formation of carbonyl groups and, presumably, the accompanying C—C bond cleavage.

3 Characterization of Carbonyl Functional Groups in Oxidized PP with IR Spectroscopy

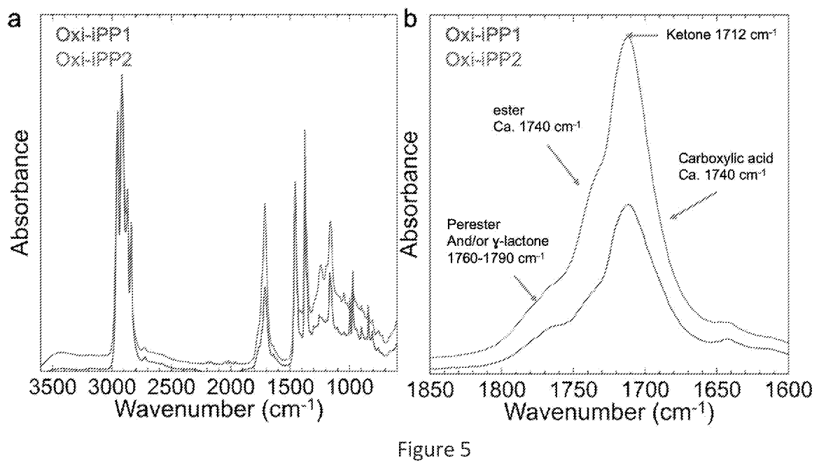

The IR spectra of oxi-iPP1 and oxi-iPP2 are shown in FIG. 5a. Increased carbonyl and hydroxyl peak intensities were observed for oxi-iPP2. The peak region for the carbonyl groups is magnified in FIG. 5b. In addition to the ketone peak with a maximum intensity at 1712 cm-1, additional peaks representing ester (ca. 1740 cm⁻¹), perester and/or γ-lactone (ca. 1760-1790 cm⁻¹) are present. The IR signal for carboxylic acids (ca. 1700 cm⁻¹) overlaps with that of the ketone groups.

### 4 Characterization of Oxi-iPP1 Using NMR Spectroscopy

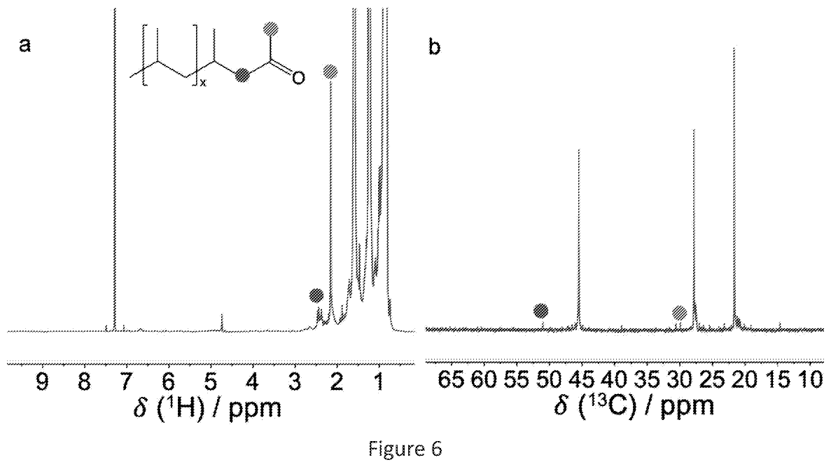

The chemical structure of oxi-iPP1 was characterized by ¹H and ¹³C NMR spectroscopy. In the ¹H NMR spectrum of oxi-iPP1, a sharp peak at ca. 2.1 ppm and small peaks at ca. 2.4 ppm are assigned to methyl and methylene protons adjacent to a terminal (methyl) ketone (FIG. 6a), consistent with TBHP cleavage of the C—C backbone in PP. In the ¹³C NMR spectrum, except for the three typical carbon resonances of iPP, additional small peaks were observed at ca. 30 and 51 ppm (FIG. 6b). They are attributed to the primary and secondary carbons, respectively, located adjacent to the terminal ketone.

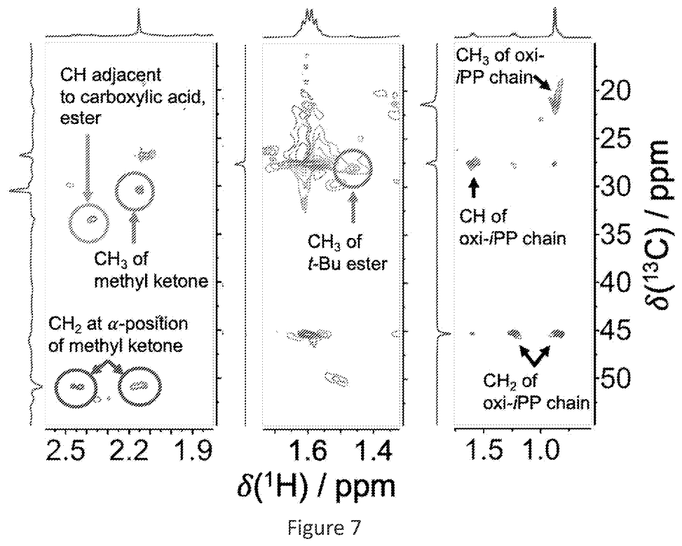

The methyl ketone assignment was confirmed by 2D HSQC NMR, which shows a strong correlation between the signals for the methyl protons and the methyl carbon bonded to the ketone (red circle, FIG. 7). The peak marked with a blue circle indicates the correlation between the methylene protons and the methylene carbon bonded to the ketone (FIG. 7).

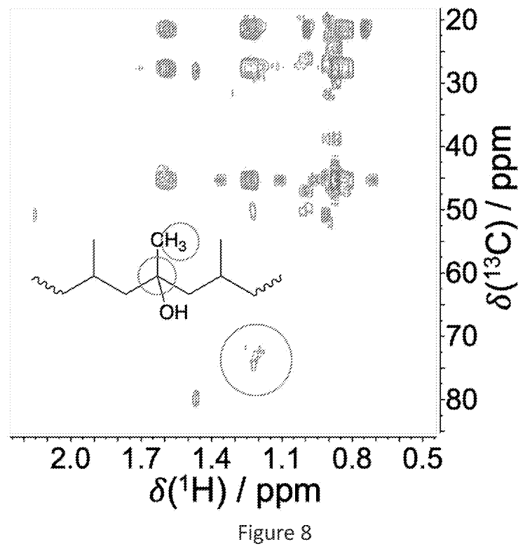

The HSQC NMR spectrum also reveals a correlation at 2.3/34 ppm (¹H/¹³C) (FIG. 7a, orange circle). It is assigned to the methylene group adjacent to an ester carbonyl. The 1H signal at 1.4 ppm is attributed to methyl protons of a tBu ester. The Bu group is originally derived from TBHP. It correlates with the carbon peak at 1.4/28 (¹H/¹³C) ppm (green circle). The assignment to a fBu ester was confirmed by comparison to the chemical shifts of t-butyl propionate. In addition, the 2D HMBC NMR spectrum shows a correlation at 1.2/74 (1H/13C) ppm between the methyl protons and the tertiary carbon bonded to the alcohol group (FIG. 8).

### 5. Effect of TBHP: PP Ratio

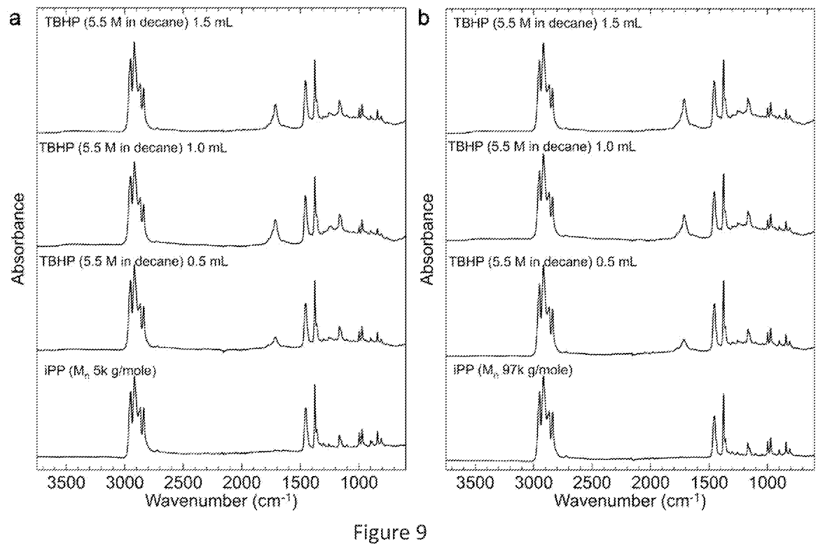

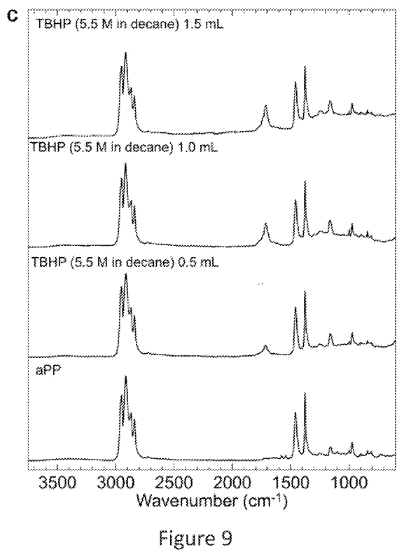

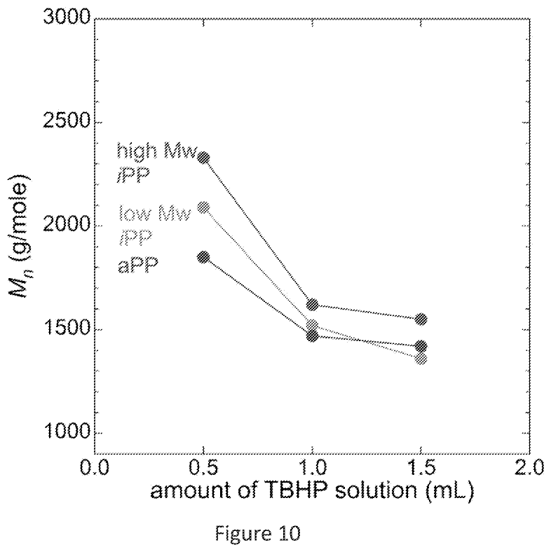

In order to optimize the TBHP: PP ratio, experiments were conducted using 400 mg PP and TBHP volumes from 0.5 to 1.5 mL. For all three PP materials (low/high MW iPPs and aPP), increasing the amount of TBHP from 0.5 to 1.0 mL resulted in increased relative intensity for the C═O stretching mode at ca. 1700 cm⁻¹ (FIG. 9). However, a further increase to 1.5 mL did not give rise to a further increase in peak intensity. The GPC results agree with this interpretation of the IR spectra: using 0.5 mL TBHP resulted in Mₙ values of 1900, 2100, and 2300 g/mol for three types of oxi-PP, decreasing further with 1.0 mL TBHP for all PP types, but negligible further decreases were found with 1.5 mL TBHP (FIG. 10). Although more TBHP cleaves more C—C bonds overall, the corresponding increase in the amount of decane solvent also leads to more decane oxygenates.

The TBHP: PP ratios can also be expressed in terms of wt. %, so that the experiments described above correspond to 10-200 wt % TBHP (relative to the mass of PP). However, as described above, this range can be modulated depending on the desired molecular weight of the oxidized PP. For example, with 60 wt % TBHP, the MW of the wax product was about 2300 g/mol. Using a smaller amount of peroxide gives a higher final molecular weight for the wax.

### 6. Extension to Post-Consumer PPs

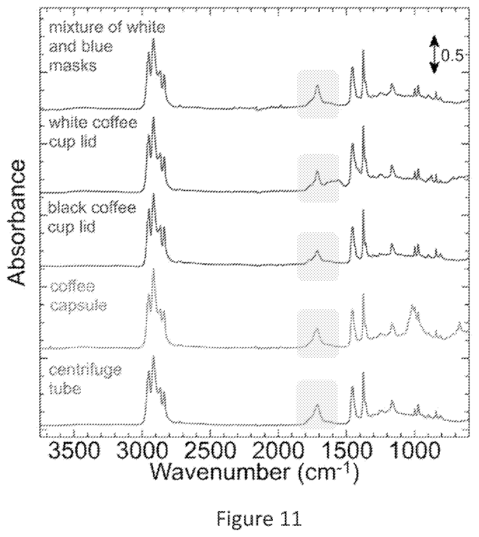

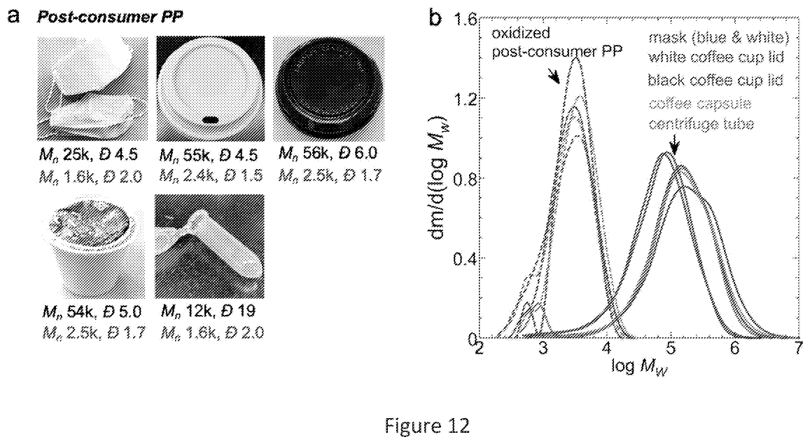

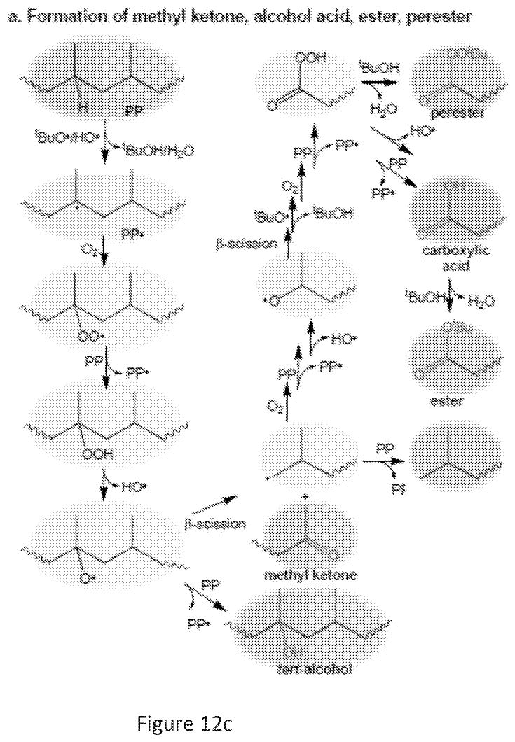

The TBHP oxidation of PP can be applied to post-consumer PPs. Various PPs (white and blue disposable masks, disposable white or black coffee cup lids, a coffee capsule, and a centrifuge tube) were subjected to the reaction condition described above. In the IR spectra of each oxidized material, intense carbonyl peaks (ca. at 1700 cm⁻¹) were observed (FIG. 11), consistent with the results for pure PP. Even in the presence of the unknown additives, the oxidized post-consumer PPs showed greatly decreased molecular weights (Mₙ ca. 2,400 g/mol for coffee cup lids and coffee capsule, Mₙ ca. 1,600 g/mol for centrifuge tube, and the mixture of white and blue disposable masks) after the oxidation reaction (FIG. 12).

### Second Example: Oxidative Cleavage of Polyethylene (PE)

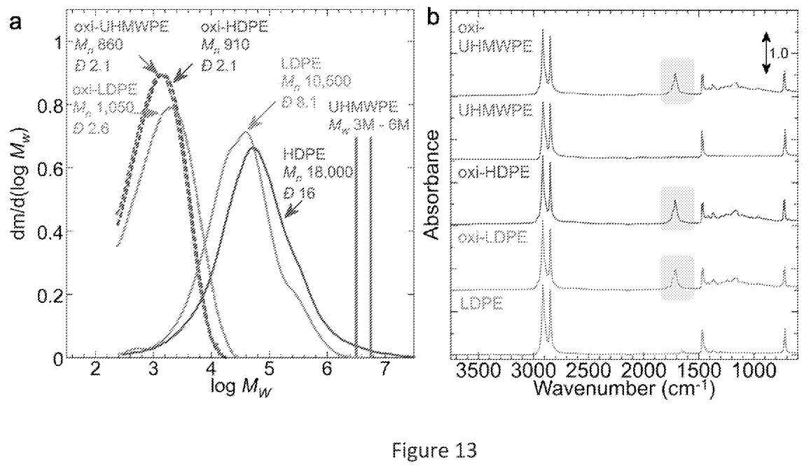

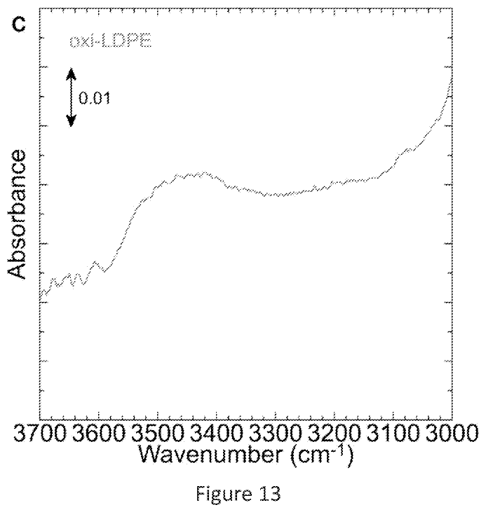

TBHP oxidative cleavage of PE was performed at 150° C. Significant chain cleavage was observed, with similar final molecular weights (Mₙ ca. 1,000 g/mol) for various PE grades (LDPE, HDPE, and ultra-high MW PE), as shown in GPC (FIG. 13a). The IR spectra of oxi-PEs confirm the presence of both carbonyl groups (FIG. 13b), and alcohol groups (FIG. 13c).

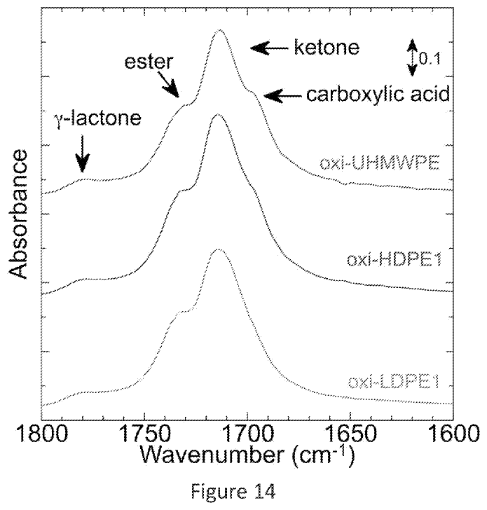

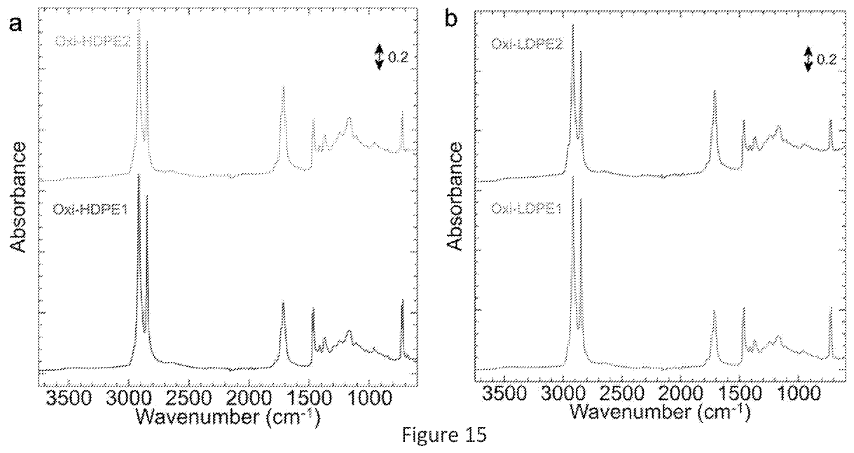

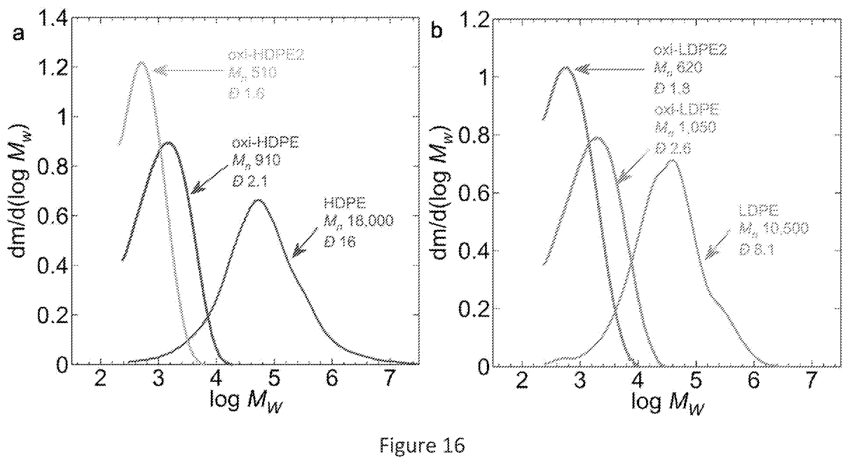

When the peak region for carbonyl groups of oxidized PE is magnified (FIG. 14), it is clear that the ketone peak at 1714 cm⁻¹ overlaps with additional peaks for carboxylic acids (ca. 1700 cm⁻¹), esters (ca. 1740 cm⁻¹), and peresters/γ-lactones (ca. 1780 cm⁻¹). The origin of carboxylic acids may be the formation of aldehyde end-groups are a result of C—C bond cleavage, followed by further oxidation of the aldehydes to carboxylic acids. Further reaction of the oxidized PEs with TBHP resulted in higher carbonyl peak intensities (FIG. 15) and molecular weights that decreased from ca. 1000 to ca. 500 g/mol (FIG. 16). Thus, the oxygen content and chain lengths can be readily tuned by the amount of TBHP used in the reaction.

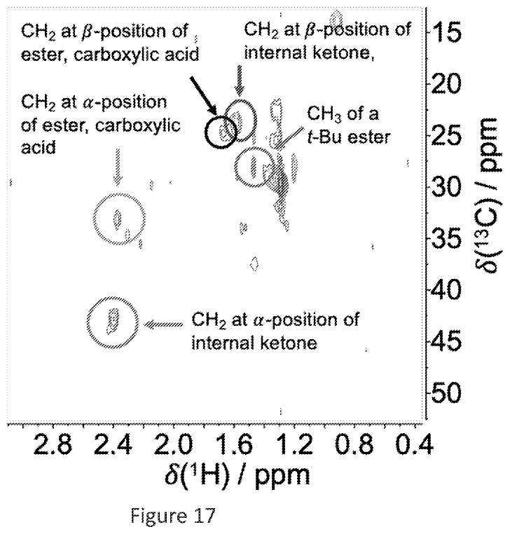

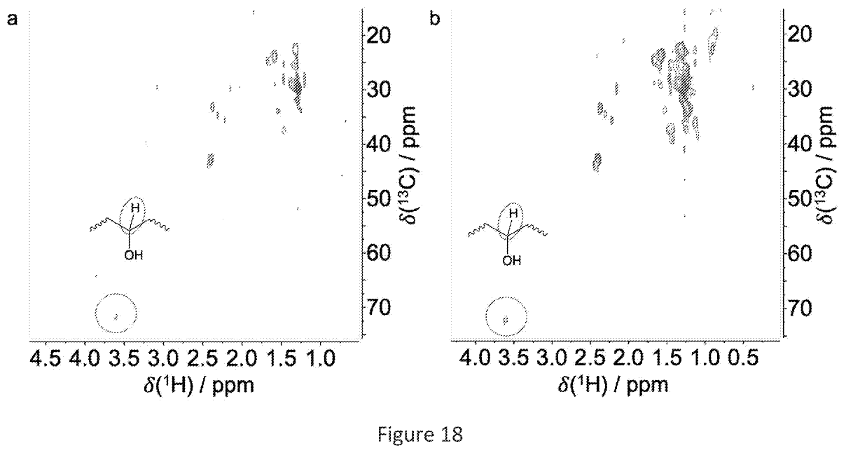

The HSQC NMR of oxi-HDPE shows correlations for CH₂ groups adjacent to the ketone (red circle, FIG. 17) as well as CH₂ groups adjacent to ester and carboxylic acid groups (orange circle). The correlation for the CH₃ groups of t-butyl esters (green circle) suggests that some ester groups are formed by reaction of the carboxylic acid groups with t-butanol. The correlation between the methine proton peak and the carbon of a secondary alcohol at 3.6/72 (1H/13C) ppm (FIG. 18) confirms the formation of these alcohol groups.

### Third Example: Use of Different Solvents and Peroxides

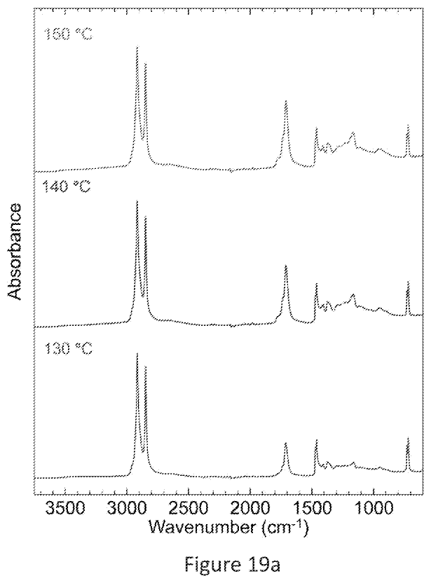

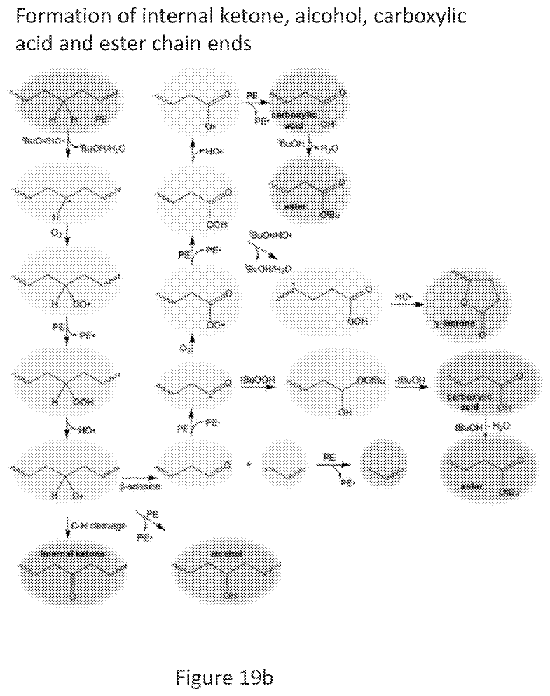

In one example, the reaction of PE (Mₙ 1740 g/mole, PDI 2.5) or LDPE (Mₙ 10,500 g/mole, PDI 8.1) with H₂O₂ (30 wt %) in H₂O (solvent) at 150° C. resulted in the formation of oxidized PE as confirmed by the IR spectra (FIG. 19). Under these conditions, a homogeneous solution was also achieved-Cumene hydroperoxide and TBHP were also both successfully utilized as peroxide sources for forming oxidized PE.

We screened several solvents to find those that solubilize LDPE at T≤150° C. The results are shown in Table 1. Ideally, a good solvent should not be more readily oxidized than the polymer. If there is competition in the oxidation reaction between solvent and polymeric substrate, the goal is to be able to solubilize the substrate in the lowest amount of solvent possible.

At 100° C., LDPE was found to be soluble in isooctane, and partially soluble in DCE. Consequently, isooctane was chosen for the oxidation of LDPE with peroxides to study the effect of lower temperature on chain cleavage and oxygen incorporation on the polymer chain.

TABLE 1
Solubility screening of LDPE^{a}

| | Temp | | | Temp | |
|---|---|---|---|---|---|
| Solvent | [° C.] | Solubility | Solvent | [° C.] | Solubility |
| n-decane | 85 | no | dichloroethane | 85 | no |
| | | | (DCE) | | |
| | 150 | PE melts, but | | 100 | partially |
| | | is not soluble | | | soluble |
| isooctane | 85 | no | water/acetonitrile | 85 | no |
| | 100 | soluble | | 100 | no |
| | | | | 110 | no |

^{a}Mₙ = 10,500 g/mol, Ð = 8.1, 200 mg in 1 mL solvent

### Fourth Example: Oxidation of Polystyrene

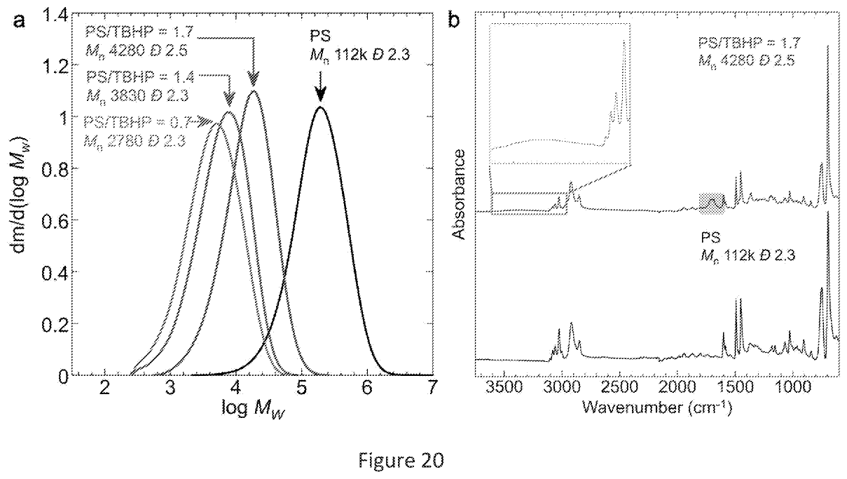

PS can be oxidized by peroxides in a similar way. FIG. 20a shows the molecular weight change for PS after its oxidation by TBHP, from 112,000 g/mol to several thousand g/mol. IR spectra of oxidized PS show new peaks at 1700 cm-1 indicating the formation of carbonyl groups such as carboxylic acids and phenyl ketones (FIG. 20b). The broad peak at 3400 cm⁻¹ confirms the formation of alcohol groups on the chain.

### Fifth Example: Oxidation of a PP-PE Mixture

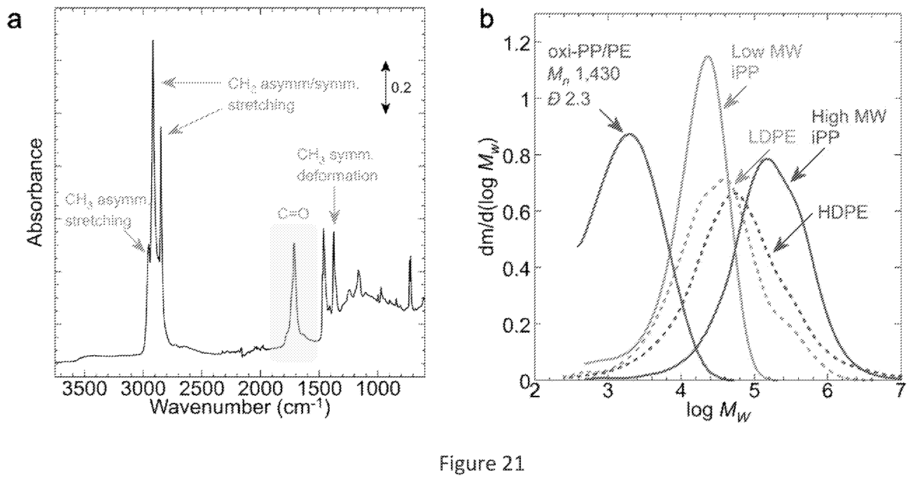

In one example, a mixture of PP and PE is simultaneously oxidized and converted to polar wax. A mixture made from high and low molecular weight iPP, LDPE, and HDPE (0.100 g each, 0.400 g total) was heated with TBHP (1.5 mL, 5.5 M in n-decane) at 150° C. for 24 h. The IR spectrum of the product confirms that it contains a mixture of oxi-iPP and oxi-PE (FIG. 21a). GPC analysis confirms the low molecular weight and narrow molecular weight distribution of the oxi-PP/PE mixture (Mₙ 1,430 g/mol, Ð=2.3, FIG. 21b). Thus PP and PE can be processed together to produce polar waxes.

### Sixth Example: Oxidation of a Mixture of Post-Consumer HDPE and iPP

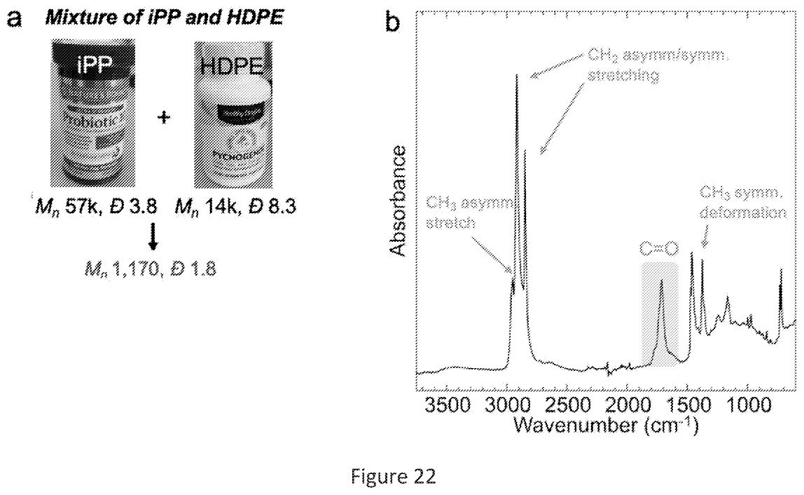

A mixture of HDPE and iPP bottles including their colored additives and labels (FIG. 22a) was oxidized. The molecular weight decreased to Mₙ 1,170 g/mol, Ð=1.9 (FIG. 22a) and the IR spectrum of the product mixture resembles that of an oxi-PP/PE mixture (FIG. 22b). Thus oxidative cleavage by TBHP is applicable to real PP and PE waste, converting it to oxidized waxes under relatively mild conditions without the need for a catalyst.

### Seventh Example: Measurement of Saponification, Acid Number, and Total Oxygen Content

Table 1 illustrates results of measurement of the saponification and acid numbers, and total oxygen contents for various oxidized polyolefins. The method of obtaining molecular weight (MW) is described in Appendix B of the priority application U.S. Provisional Application Ser. No. 63/433,849.

TABLE 2
Chemical and physical properties of oxidized polyolefins

| | | | | | Oxygen | Total | Max. [O] | |
|---|---|---|---|---|---|---|---|---|
| | Mₙ | Acid | Saponification | Oxygen content | content | oxygen | utilization | |
| | (g/mol), | number | number | from COOH and | from OH | content | efficiency | Viscosity ^{b} |
| Polar wax | D | (mg KOH/g) | (mg KOH/g) | COOR (wt %) | (wt %) | (wt %) | (%) ^{a} | (mPa · S) |
| Oxi-iPP1 | 1620, 1.8 | 26.9 | 42.1 | 2.3 | 2.3 | 6.1 ± 0.3 | 28 | 52.7 |
| Oxi-HDPE1 | 910, 2.1 | 40.4 | 77.4 | 4.4 | 2.8 | 10.3 ± 0.8 | 31 | 75.6 |
| Oxi-LDPE1 | 1050, 2.6 | 41.5 | 80.8 | 4.6 | 2.3 | 10.1 ± 0.1 | 31 | 264 |
| Oxi-PP/PE | 1430, 2.3 | 35.9 | 79.5 | 4.5 | 2.3 | 10.1 ± 0.1 | 31 | 42.5 |
| Oxi-iPP2 | 900, 1.7 | — | — | — | — | 9.1 ± 0.1 | 21 | — |
| Oxi-HDPE2 | 510, 1.6 | — | — | — | — | 12.1 ± 0.1 | 18 | — |
| Oxi-LDPE2 | 620, 1.8 | — | — | — | — | 12.0 ± 0.7 | 18 | — |

^{a} Assuming one oxygen atom is provided by each TBHP molecule, since most TBHP is eventually converted to t-butyl alcohol.
^{b} Viscosity values are measured at 140° C. and shear rate of 6 s⁻¹

Reaction conditions) Oxi-iPP1: iPP 0.4 g, TBHP (5.5 M in decane) 1.0 mL, 150° C., 24 h. Oxi-HDPE1 and oxi-LDPE1: HDPE or LDPE 0.267 g, TBHP (5.5 M in decane) 1.0 mL, 150° C., 24 h. Oxi-PP/PE: low and high MW iPP 0.1 g each, HDPE 0.1 g, LDPE 0.1 g, TBHP (5.5 M in decane) 1.5 mL, 150° C., 24 h. Oxi-iPP2, oxi-HDPE2, and oxi-LDPE2: additional 1 mL of TBHP was added after drying the reactor containing oxidized products. The reaction was again conducted at 150° C. for 24 h.

The saponification number is the amount of potassium hydroxide in milligrams required to saponify one gram of the oxidized polyolefin. KOH reacts with both the carboxylic acid and ester groups in the oxidized polyolefin. The amount of KOH that reacts is the saponification number. By varying the amount of peroxide and the duration of the oxidation reaction, or the number of times the reaction is repeated, the saponification number can be varied in a range of (30≤saponification number≤200).

The acid number is the amount of potassium hydroxide in milligrams required to neutralize 1 g of the oxidized polyolefin dissolved in xylene. By varying the amount of peroxide and the duration of the oxidation reaction, or the number of times the reaction is repeated, the acid number can be varied in the range 15-100.

In order to estimate the oxygen content due to alcohol groups, an acetylation reaction was conducted. Acetylation converts alcohol groups to esters. The increase in the amount of esters was obtained by measuring the saponification number of the acetylated product.

Total oxygen content was measured by CHN (carbon, hydrogen, nitrogen) elemental analysis. Since the materials do not contain nitrogen, the wt % oxygen in the oxidized product was calculated by subtracting the content of carbon and hydrogen from 100 wt %.

### Eighth Example: Examination of the Dissolution Process

Without being bound by a particular scientific theory, the oxidation and dissolution may proceed according to a variety of scenarios.
First Scenario: The polyolefin may dissolve in the solvent at a set temperature, and then react with the peroxide oxidant.
Second scenario. The polyolefin partially dissolves in the solvent at the set temperature, the dissolved part reacts first, and then the undissolved part dissolves and reacts in the process. Evidence: At 140° C., iPP (Mₙ: 97k, M_{w} 340k) was not fully dissolved in TBHP (5.5 M decane) 1.0 mL at 140 C. Thus, in the case of iPP oxidation, iPP was partially dissolved.
Third Scenario. The polyolefin softens and swells in the solvent, or melts and forms two liquid phases with the solvent, the peroxide penetrates into the polymer and reacts to oxidize the polyolefin. The partially oxidized polymer and solvent form a homogeneous solution.

### Solubility and Oxidation

TABLE 3

| | | Oxidant/Solvent | |
|---|---|---|---|
| Polyolefin | Solubility | combination | Oxidation |
| iPP | Solid at 150° C. | H₂O₂/H₂O | No |
| PE | liquid at 150° C. | H₂O₂/H₂O | Yes |
| PE | liquid at 150° C. | TBHP/decane | Yes |
| iPP | Solid beads at 150° C. | TBHP/H₂O | No |
| iPP | Two non-miscible | Cumene | No |
| | phases at 150° C. | hydroperoxide/cumene | |
| iPP | Soluble at 150° C. | TBHP/Decane | Yes |
| PE | liquid at 150° C. | Cumene | Yes |
| | | hydroperoxide/cumene | |

Our data shows that at 150° C. in H₂O₂/H₂O, iPP is a solid. But, PE melts at 150° C., resulting in separate PE and H₂O₂/H₂O phases. As PE chains are oxidized by H₂O₂, a homogeneous solution of oxidized PE and water is achieved. In addition, even though PE is only partially dissolved in decane at 150° C., as PE chains are oxidized by TBHP, a homogeneous solution of oxidized PE chains and decane is formed during the reaction. Improved oxidation is not achieved for the liquid state of oxidized iPP with TBHP/H₂O solution. So for iPP, ‘dissolution’ is required for oxidation. Thus, our data (see also e.g. slides 22-26 of Appendix C of the priority application U.S. Provisional Application Ser. No. 63/433,849) shows that PP/PE in solution or melt state is needed for effective oxidation using peroxide. PE can be efficiently oxidized by peroxides both in solution and melt due to its lower melting temperature (~160° C. for iPP, ~110° C. for LDPE, and 130° C. for HDPE). On the other hand, much higher temperature (>160° C.) is needed to melt iPP; however, peroxides decompose quickly at such high temperature so the reaction is not effective. Thus, oxidation of polyolefins in hydrocarbon solvents can be used to lower reaction temperature to obtain commercially relevant reaction rates while avoiding undesirably higher temperatures at which the peroxide may decompose.

Since both PP and PE were at least partially soluble in hydrocarbon solvents such as decane under the experimental conditions (temperature, loading etc.), the use of hydrocarbon solvents can be useful for enhancing oxidation at lower temperatures.

### Ninth Example

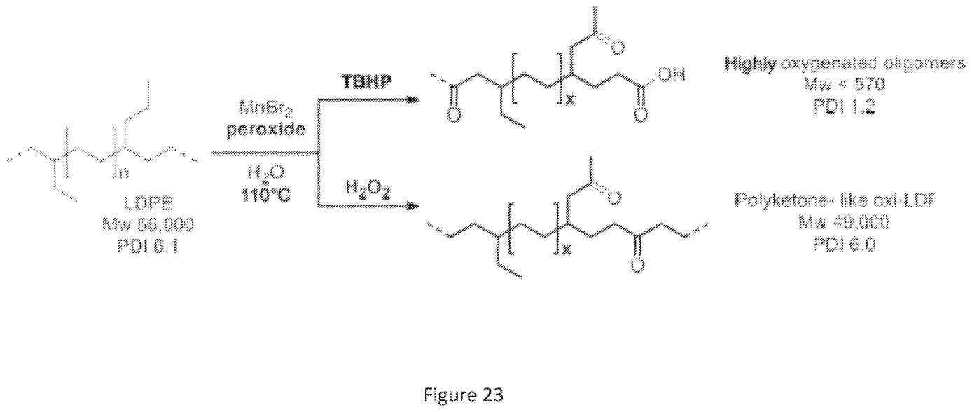

An approach for oxidizing LDPE selectively was discovered. The method uses a peroxide as the oxidant, water as the reaction medium, and MnBr₂ as the catalyst, at 110° C. (FIG. 23). When the oxidant is tert-butyl hydroperoxide (TBHP), oxidation occurs primarily at the tertiary carbons at LDPE branch points, leading to C—C bond cleavage along the polymer backbone and formation of oligomers with, ester, and ketone functionalities (M_{w}<600 g/mol, Ð=1.2). By changing the oxidant to H₂O₂, the process redirects selective cleavage to C—H bonds at secondary carbons, resulting in a polyketone-like product with internal ketones on the main chain and methyl ketones on the branches. Also esters are formed, in smaller amounts. This groundbreaking LDPE oxidation process with H₂O₂ represents the first synthetic strategy for obtaining polyketone-like structures through direct PE oxidation.

### Results and Discussion

### 1. Product Characterization

At the initiation of the reaction (time=0), LDPE is not soluble in the reaction medium (water) under the reaction conditions (110° C.). However, as oxidation progresses, the solubility of the LDPE increases. After 24 h, the solution appears homogeneous. The products start to precipitate as white solids when the reaction mixtures are cooled to room temperature.

### (i) Use of TBHP as Oxidant, to Obtain Small Oxygenated Oligomers

The reaction conditions of 0.05 g LDPE (M_{w} 56,000, Ð 6.1), 1 mL tBuOOH (70 wt % in H₂O), 2.5 wt % MnBr₂ at 110° C. for 24 h were used to obtain the data.

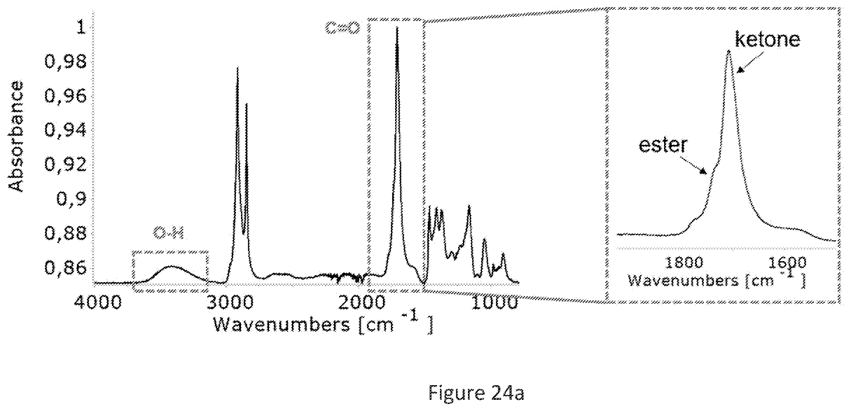

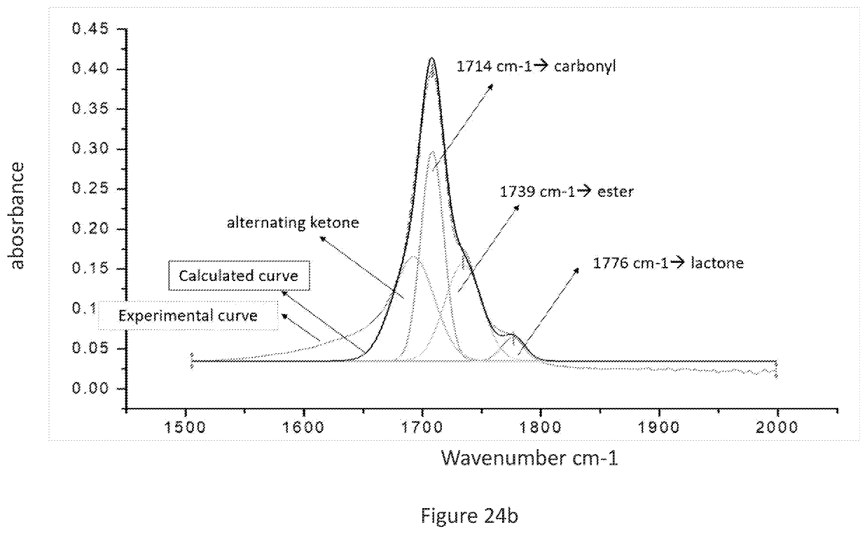

IR analysis of oxi-LDPE resulting from TBHP oxidation of LDPE catalyzed by MnBr₂ at 110° C. for 24 h shows a sharp peak at 1714 cm⁻¹ corresponding to a carbonyl stretching mode, as well as a broad O—H stretch at 3300-2500 cm⁻¹ (FIG. 24). Closer inspection of the carbonyl region reveals, in addition to the most intense peak assigned to ketones (1712 cm⁻¹), shoulders characteristic of esters (ca. 1740 cm⁻¹) and carboxylic acids (1700 cm⁻¹). [1] The presence of carboxylic acid groups is also consistent with O—H stretching.

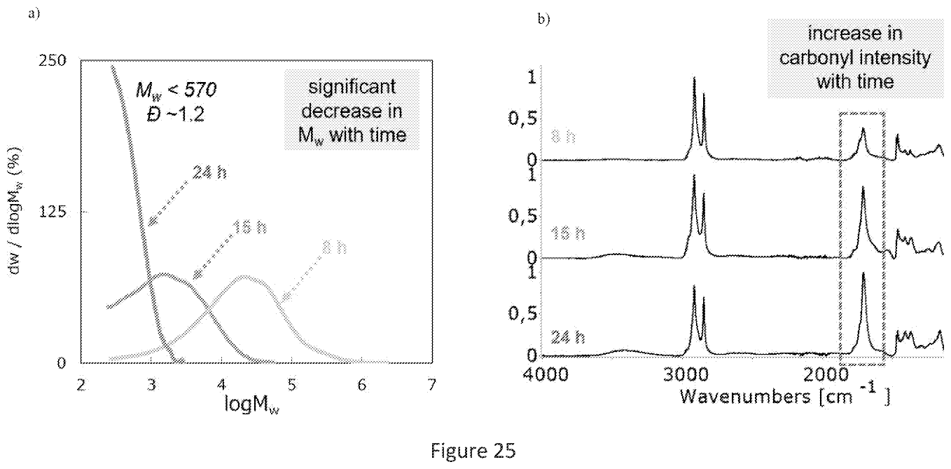

The intensity of the carbonyl peak in the IR spectrum is directly proportional to the level of oxygen incorporation in oxi-LDPE. FIG. 25b shows how the intensity of this peak increases with reaction time, indicating a progressive increase in oxygen content from 8 to 24 h. These results from FIGS. 25a and 25b suggest that oxidation proceeds via cleavage of C—C bonds in the polymer backbone, via a β-scission mechanism. FIGS. 25a and 25b clearly show that the M_{w} decreases with the increase of oxygen content over time.

The data of FIGS. 25a and 25b shows a low molecular weight wax of M_{w}=570, D 1.2

has internal ketones including alternating ketones, terminal ketones, esters, and hydroxy groups. Surprisingly no acid groups are detected from NMR and titration. Trace amount of lactone groups are present in the wax as identified in ¹H NMR and as hypothesized from IR analysis (FIG. 24b). The wax has a total oxygen content of 14.3 wt % from elemental analysis and has a saponification number of 124 mg KOH/g.

0.05g LDPE was used in the oxidation reactions for these results. Although different quantities and ratios were studied, the standard condition is 50 mg LDPE.

(ii) Use of H₂O₂ as Oxidant, to Obtain Polyketones

The reaction conditions of LDPE 50 mg+MnBr₂ 2.5 wt %+1 mL H₂O₂ (30 wt % in H₂O) at 110° C. for 24 h were used to obtain the data.

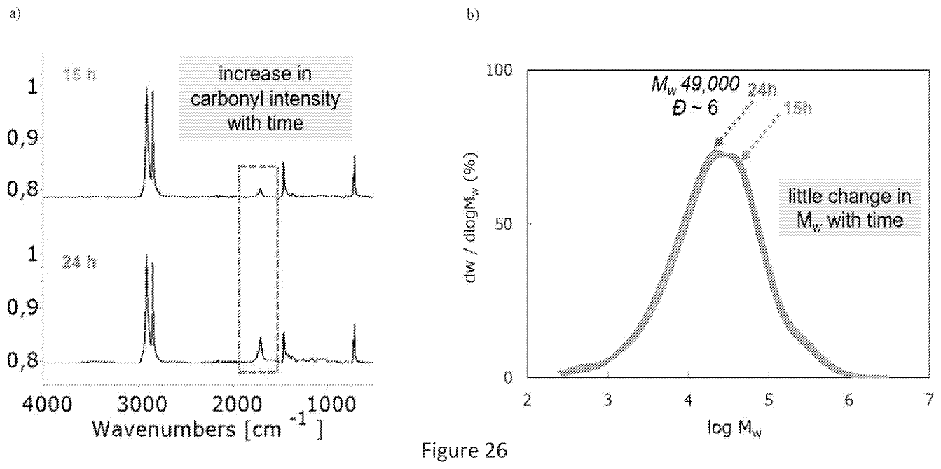

When TBHP was replaced with H₂O₂, the IR spectrum of the oxi-LDPE product shows a progressive increase in carbonyl peak intensity over time, FIG. 26a. However, the molecular weight remains almost unchanged as the reaction proceeds, FIG. 26b (the molecular weight M_{w} of the polyketone under the reaction conditions is 49000, with Ð=6.1). In this case, oxygen was incorporated onto the polymer backbone without significant chain cleavage, suggesting a C—H bond cleavage mechanism.

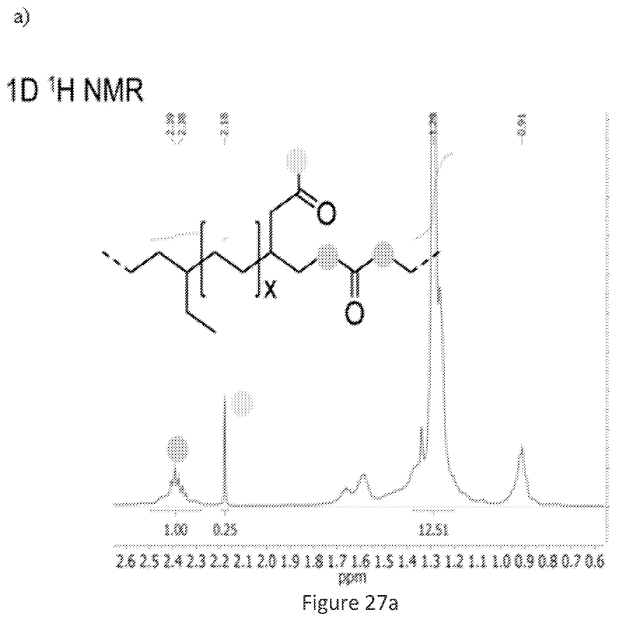

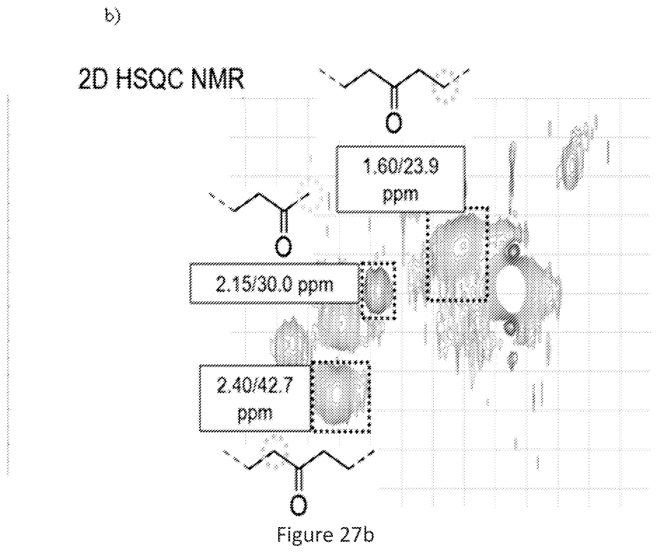

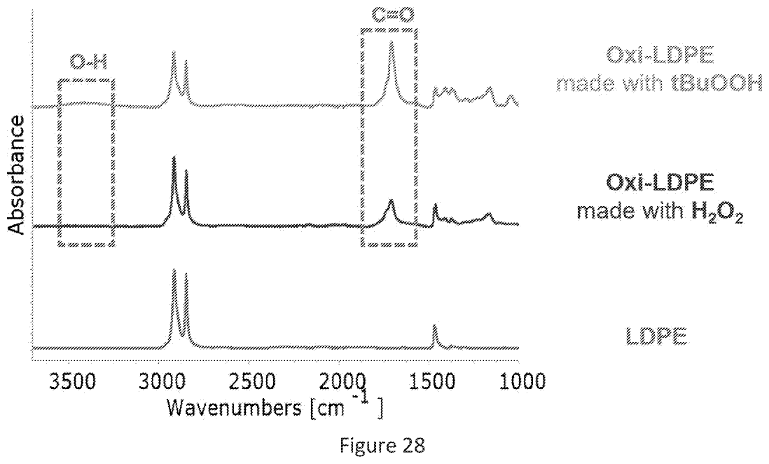

The chemical structure of oxi-LDPE was further characterized by ¹H NMR, FIG. 27a. A strong multiplet at ca. 2.4 ppm is assigned to methylene protons α to an internal carbonyl. This signal is consistent with a C—H bond cleavage mechanism. 1H NMR peaks characteristic of aldehydes, ethers, and carboxylic acids are not observed. Interestingly, there is a sharp singlet at 2.2 ppm, characteristic of methyl protons adjacent to a ketone. Methyl ketones may arise from oxidation of branches in the LDPE structure.

Strong correlations for methylene groups a and B to internal ketones are observed in the 2D HSQC NMR (green circles, FIG. 27b). The cross-peak at 2.1 ppm and ca. 30 ppm is assigned to a methyl group α to a terminal ketone (yellow circle, FIG. 27b). Ester groups are also present. Thus oxi-LDPE has a polyketone-like structure, with both internal ketones on the main chain, ester groups at the chain ends, and methyl ketones at the termination of branches.

Thus, the data shows the polyketone has ester and ketone (non-alternating) groups, wherein a majority of the ketone groups are internal ketones and a total oxygen content in the polyketone is 4.2 wt %.

The composition of the polyketone indicates it has an application as a barrier polymer or any application requiring an enhanced adhesion. The inventors hypothesize the polyketone is biodegradable in view of (4) (e.g., in soil, marine, compost, or landfill environments).

For the reaction conditions of LDPE 50 mg+MnBr₂ 2.5 wt %+1 mL H₂O₂ (30 wt % in H₂O) at 130° C. for 24 h, the carbonyl peaks have comparable intensity as when TBHP was used at 110° C. for 24 h, indicating more efficient oxidation is achieved and oxygen content is increased when the reaction temperature is increased.

0.05g LDPE was used in the oxidation reactions for these results. Although different quantities and ratios were studied, the standard condition is 50 mg LDPE.

(iii) Role of the Oxidant

The intensities of the carbonyl stretching peak at 1712 cm⁻¹ in the IR spectra of oxi-LDPE products made using TBHP or H₂O₂ are compared after 24 h reaction in FIG. 28. TBHP clearly gives products with a higher carbonyl content than does H₂O₂.

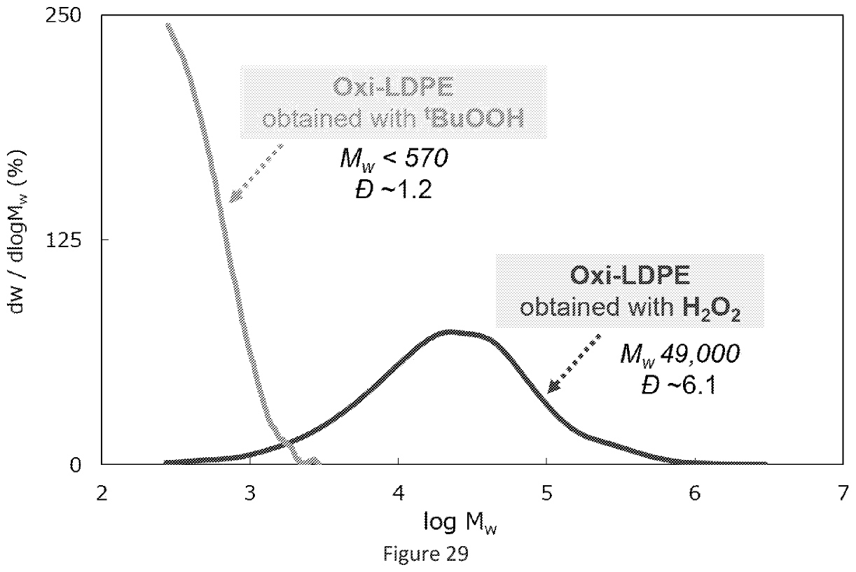

The products made with different peroxides also have very different molecular weights, FIG. 29.

The selectivity of the process is therefore strongly influenced by the choice of peroxide. When TBHP is used, the reaction leads to oxidative C—C bond cleavage. In contrast, when H₂O₂ is utilized, significant chain cleavage does not occur. The difference may be due to the conformation of the polymer chains in the two reaction solutions. More extended or open conformations should facilitate more extensive oxidation and chain cleavage by providing better access to internal sites on polymer chain, while folded or closed conformations may allow access only to sites on the external surface of the polymer, limiting the extent of oxidized polymer chain.

### 2. Role of the Catalyst

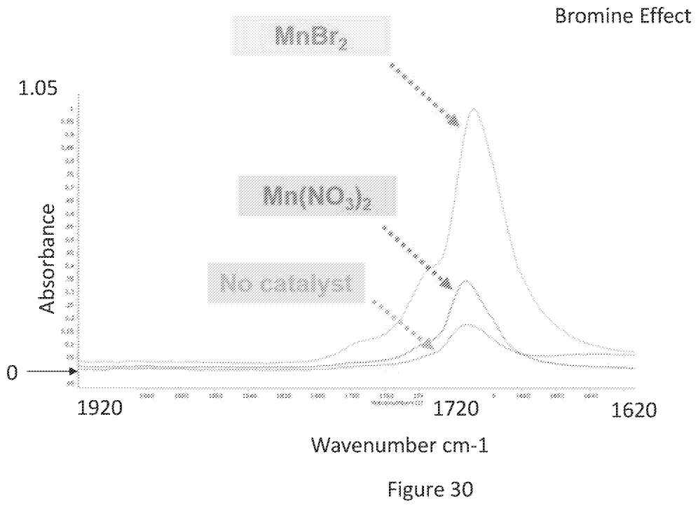

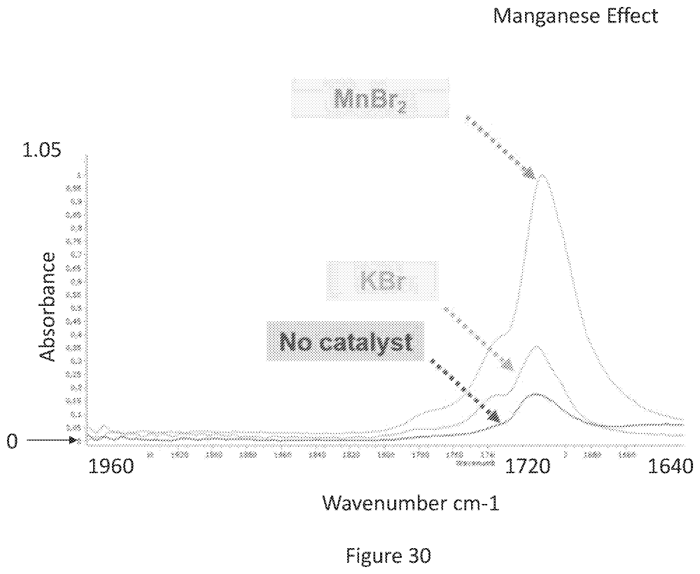

The role of the catalyst was studied varying both the metal and the anion. LDPE was oxidized with TBHP in water at 110° C. for 24 h. When the catalyst is Mₙ (NO₃)₂ (i.e., no bromide), there was a significant decrease in the intensity of the carbonyl peak compared to the reaction catalyzed by MnBr₂ (FIG. 30a). A similar decrease was observed when the catalyst was KBr (FIG. 30b). Thus both Mₙ (II) and bromide appear to play a role in the catalytic cycle.

Oxidation mechanism: Based on results previously obtained in our lab, we propose a possible mechanism for LDPE oxidation. Mₙ (II) is oxidized to Mₙ (III) by the peroxide, and Mₙ (III) oxidizes Br⁻ to Br radical. Polymer oxidation is initiated by the Br radical abstracting a H atom from the LDPE backbone, leading to secondary and/or tertiary carbon-based radicals (Scheme 1) [2] This reaction also results in reduction of Br to Br⁻.

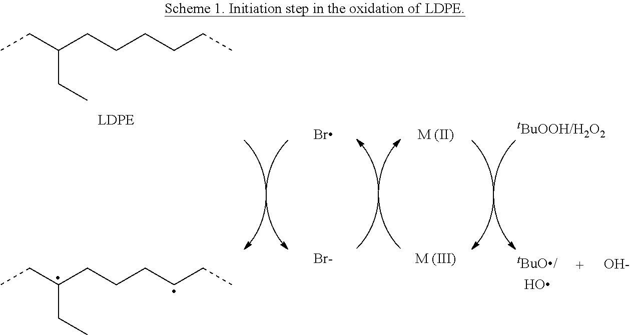

There are several possible propagation pathways, depending on the nature of the polymer radicals generated. When tertiary carbon-centered radicals are generated, they can be trapped by O₂ (formed by peroxide disproportionation) and eventually form tertiary alkoxy radicals that undergo β-scission, resulting in an alkyl ketone-terminated chain and a new, primary radical, FIG. 31. Secondary carbon-centered radicals are oxidized to secondary alkoxy radicals, which can undergo C—H bond cleavage to give an internal ketone, H atom abstraction to give a tertiary alcohol, or C—C bond cleavage to give an aldehyde-terminated chain and a new alkyl radical [3]. Further oxidation of the aldehyde gives a carboxylic acid which may react with alcohols (such as tert-butanol) present in the reaction mixture to give esters.

When TBHP is used as oxidant, the reaction proceeds mainly via oxidative C—C bond cleavage, suggesting that the primary pathway involves tertiary alkoxy radicals which undergo β-scission. In contrast, when H₂O₂ is used as the oxidant, the reaction proceeds mainly via C—H bond cleavage, suggesting that the primary pathway involves secondary alkoxy radicals.

2.5 wt % of the catalyst MnBr₂ was determined to be the optimized catalytic amount for forming the waxes and the polyketones.

### 3. Roles of the Peroxide Oxidant

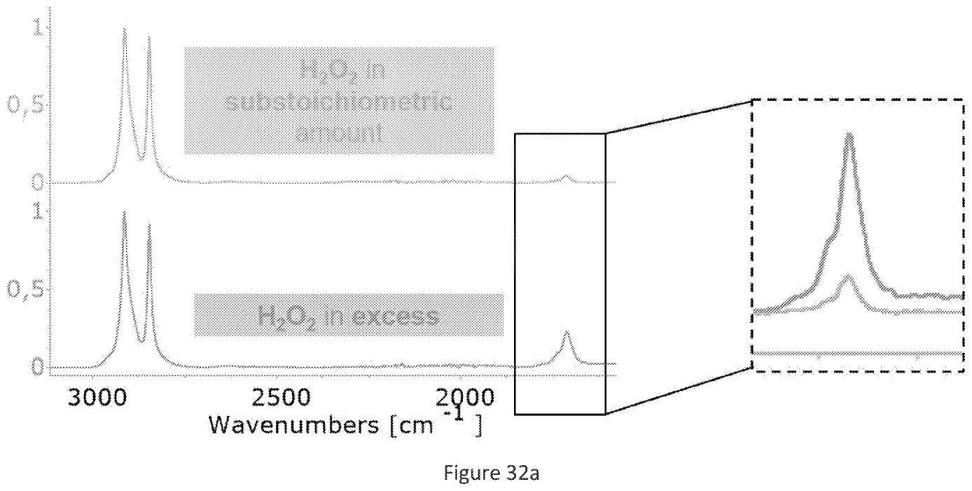

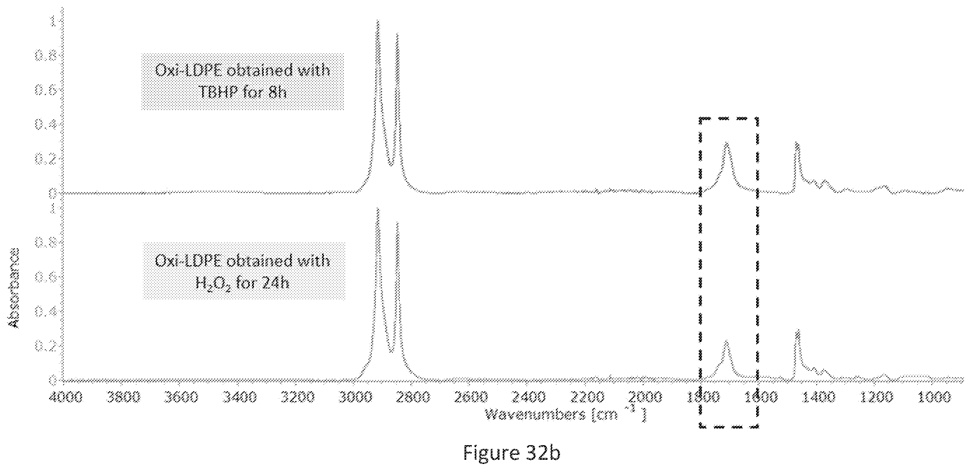

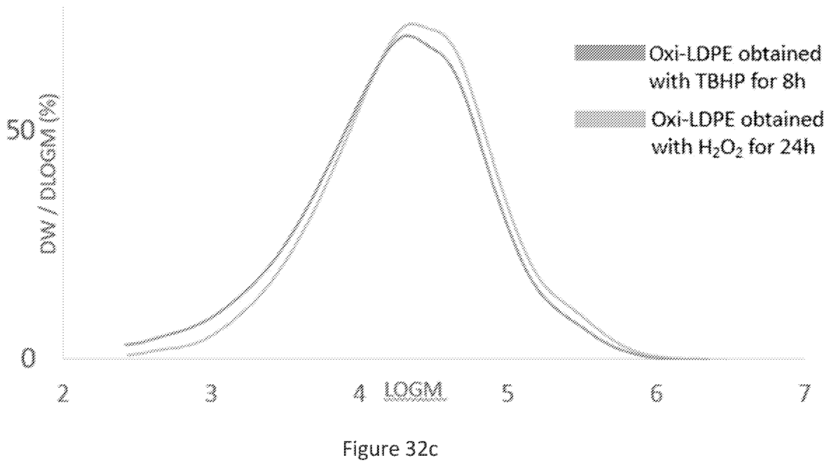

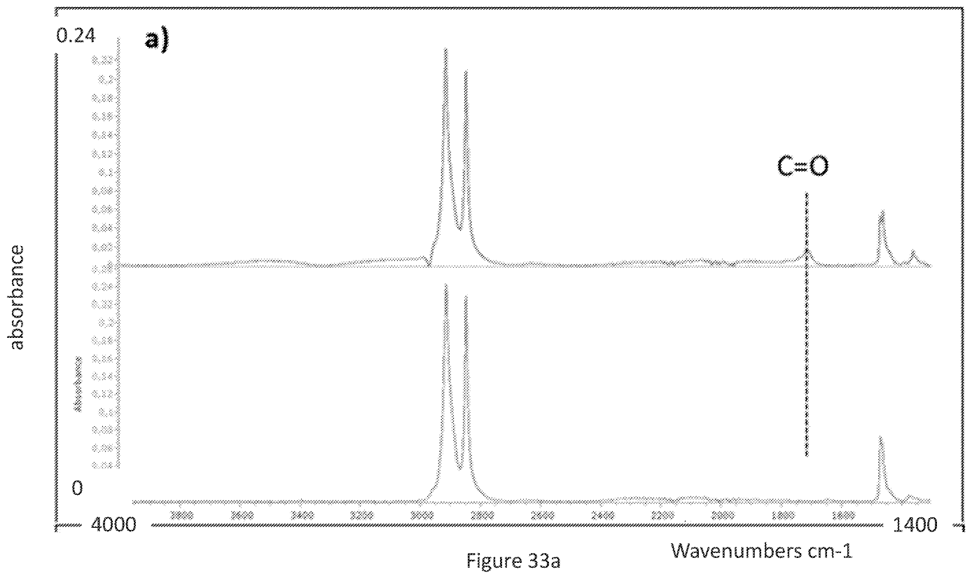

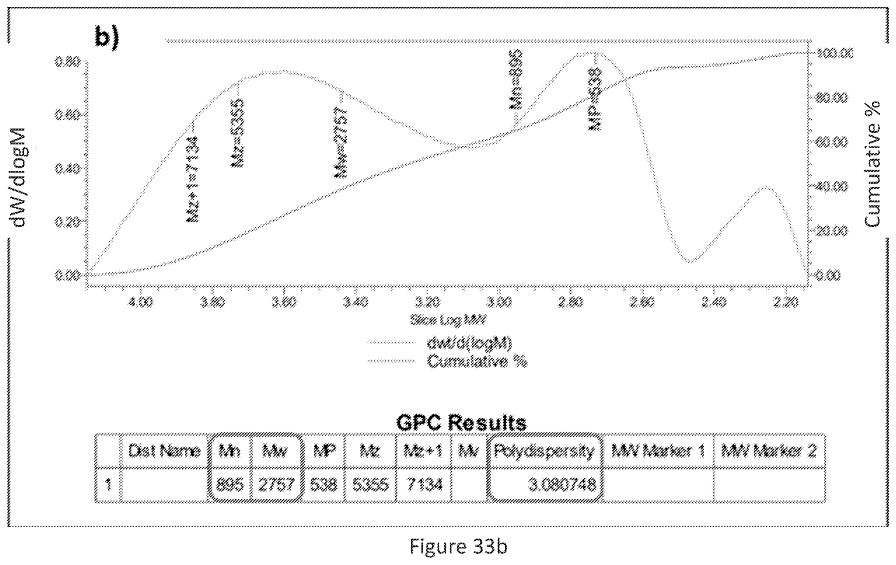

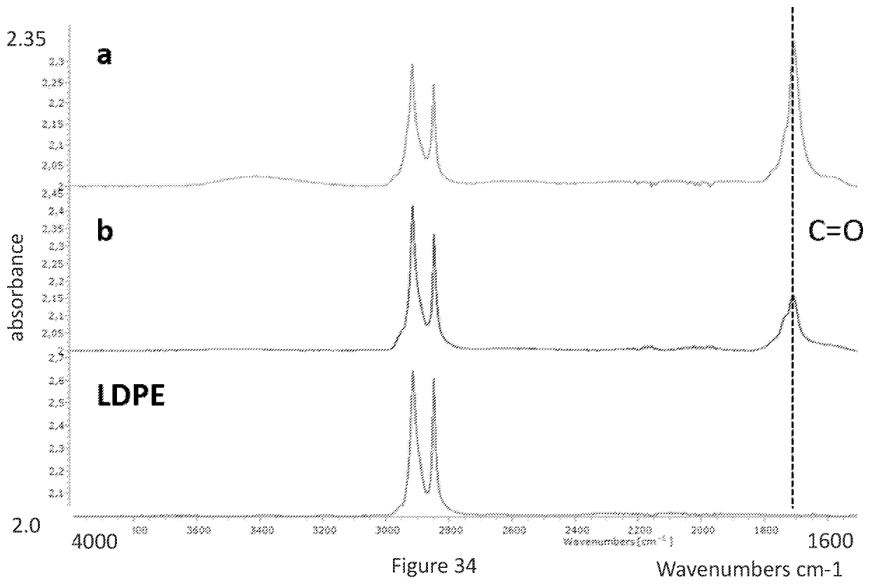

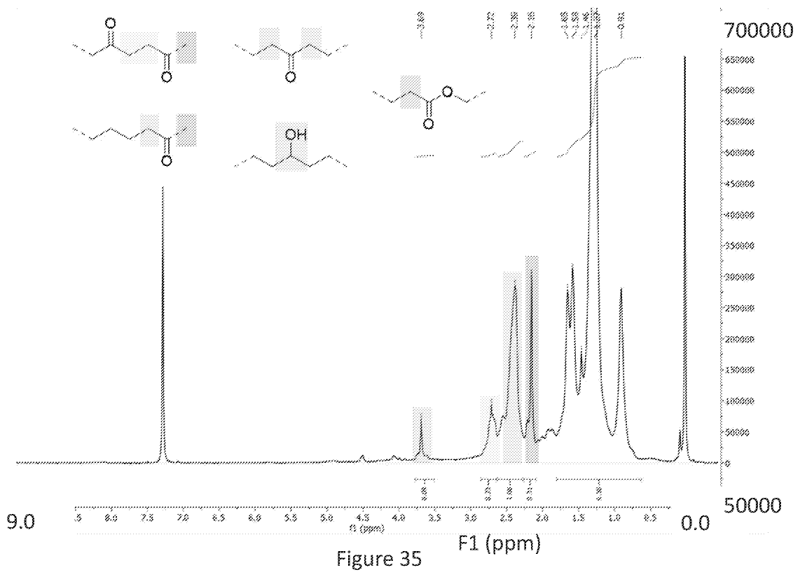

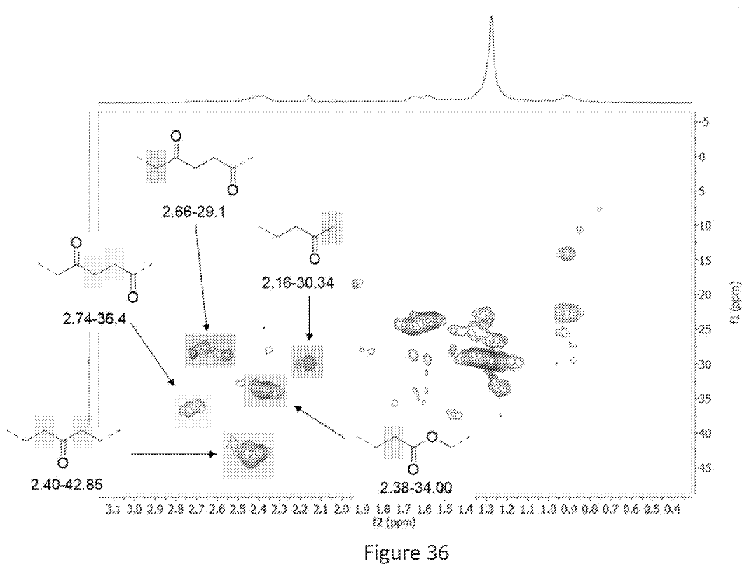

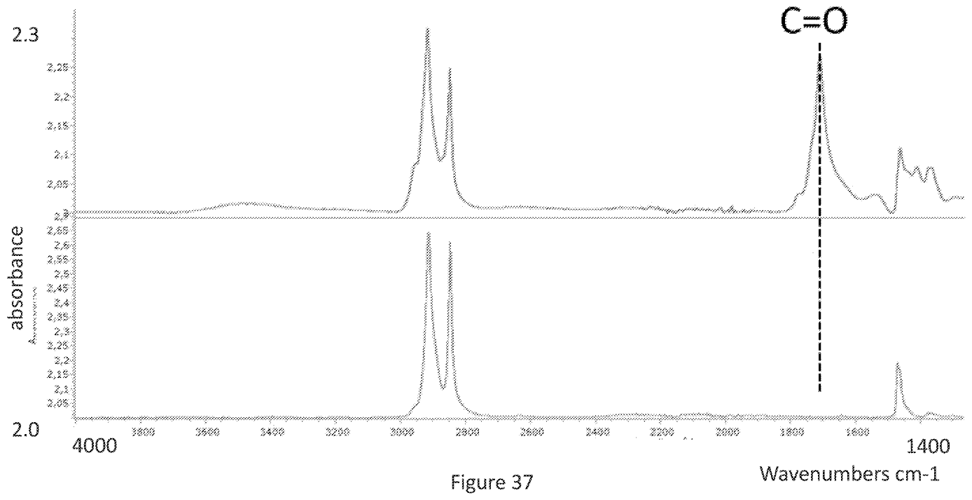

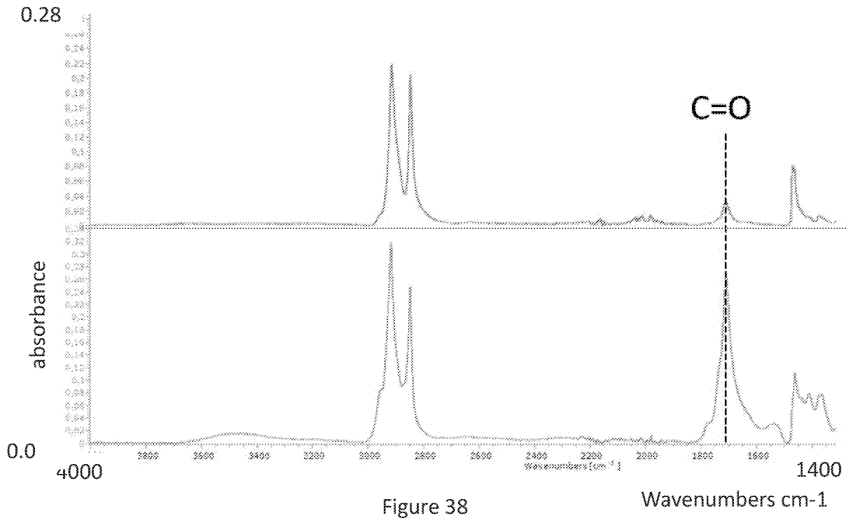

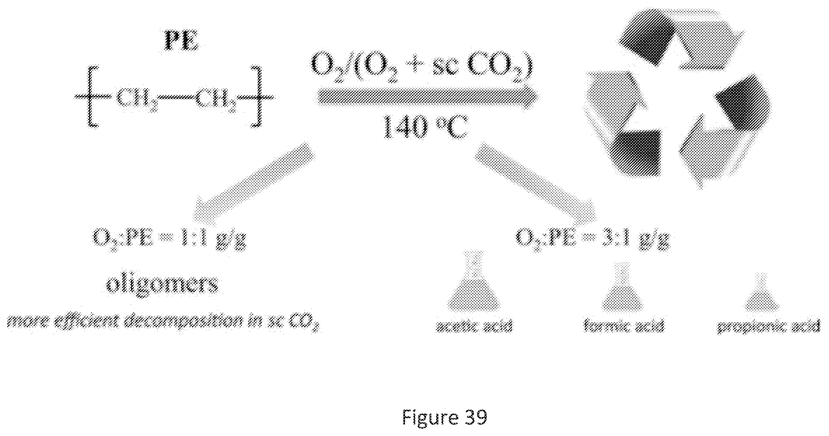

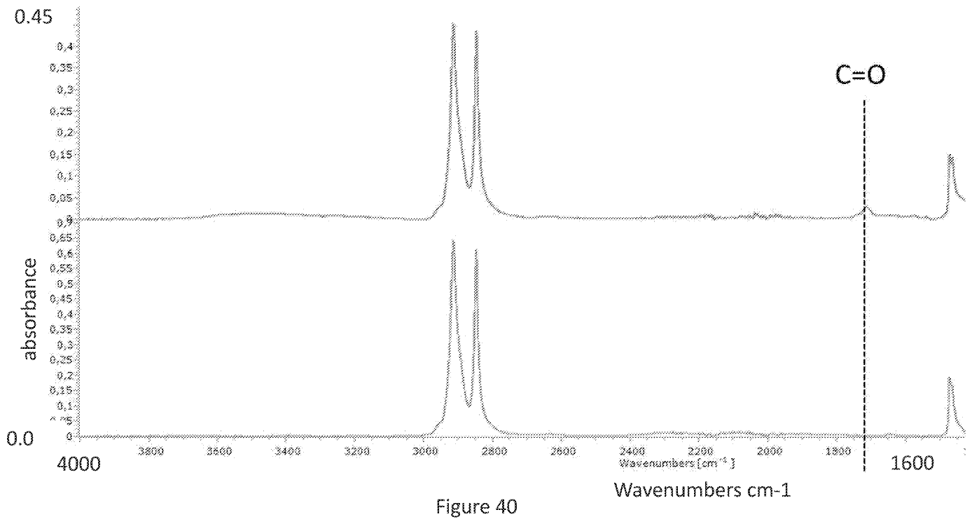

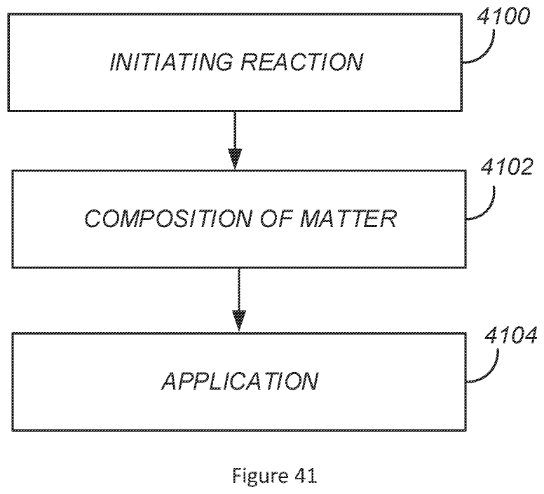

The peroxide (either TBHP or H₂O₂) may act as an initiator by oxidizing Mₙ (II) to Mₙ (III) and/or Br⁻ to Br·. It can also serve as an oxygen source for LDPE. In the benchmark reaction conditions, the peroxides are used in excess. When we lowered the amount of H₂O₂ to a substoichiometric of 0.5 amount (0.5 equivalents over ethylene monomer repeating unit), the extent of oxidation dramatically decreased. The intensity of the carbonyl stretching peak was significantly lower when the peroxide was not present in excess, FIG. 32a. This indicates that H₂O₂ is the major source of oxygen in the reaction. An analogous result was obtained for TBHP.

4. Studies of Model Compounds to Gain Insight into Reaction Mechanisms

From studies of oxidation of n-octadecane, we conclude that selectivity is the same for both peroxides at low conversion (i.e., after 1 h reaction with TBHP and after 24 h reaction with H₂O₂). In both cases, the initial oxidation products are formed by C—H bond cleavage. The origin of the large differences in rates may be as simple as the higher solubility of the alkane in the aqueous TBHP solution, relative to the aqueous H₂O₂ solution. Although both oxidants are dissolved in water, the presence of a high concentration of TBHP (and, as the reaction proceeds, tBuOH) likely increases the solubility of the alkane and therefore its apparent reactivity.

To understand how chain branching affects the mechanism, we studied the oxidation of squalane as a model compound. Organic products were identified by GC-MS. After 24 h, the conversion was ca. 85%, similar to that obtained for C-18 (n-octadecane) oxidation under the same conditions. However, the squalane products differ from those obtained with C-18. Specifically, internal ketones were not detected, although methyl ketones, esters and carboxylic acids are present. These products suggest that H atom abstraction occurs predominantly at tertiary carbons in the presence of branches. The preferential formation of tertiary radicals is favored and their subsequent oxidation leads to the production of methyl ketones via β-scission. We also investigated the reaction between squalane and H₂O₂. After 24 h at 110° C., the conversion was approx. 5%. There is minimal oxidative cleavage of C—C bonds. Consequently, TBHP appears more reactive towards squalane than H₂O₂.

Our investigation of model compounds provides valuable insight into the unexpected difference in selectivity in LDPE oxidation by the two peroxides. During the initial stages of TBHP oxidation, abundant methylene carbons undergo rapid oxidation via C—H bond cleavage. Methine carbons, while more reactive, are less abundant and are oxidized more slowly. Their reaction results in extensive chain cleavage. In contrast, when H₂O₂ is employed, oxidation is slower, and limited to the more abundant methylenes.

### 5. Tuning of Reaction Duration

As noted above, selective oxidation in low-density polyethylene (LDPE) can be tuned through the strategic choice of oxidants and reaction durations. Employing MnBr₂ as a catalyst at 110° C., this example compares the impact of H₂O₂ and TBHP on LDPE oxidation. Both oxidants similarly initiate LDPE oxidation via C—H bond cleavage, resulting in comparably oxi-LDPEs with similar oxygen content and molecular weights. However, extended reactions with TBHP uniquely induce further oxidation through β-scission of C—C bonds. These insights demonstrate the potential to control the selectivity and extent of LDPE oxidation, offering a pathway to synthesize tailored polyketone-like materials by adjusting oxidant type and reaction time. These finding align with the observations made in the analysis using model compounds.

IR spectroscopy analysis (FIG. 32b) of oxidized LDPE (oxi-LDPE), produced via the oxidation of LDPE catalyzed by MnBr₂ at 110° C. for 24 hours using H₂O₂, and oxi-LDPE generated from the oxidation of LDPE catalyzed by MnBr₂ at 110° C. for 8 hours using TBHP, revealed a pronounced peak at 1714 cm⁻¹. This peak is indicative of a carbonyl stretching mode and exhibited similar intensities in both samples.

The carbonyl peak intensity in the IR spectrum is directly proportional to the degree of oxygen incorporation in oxi-LDPE. Consequently, these experimental findings suggest that the oxygen content in both oxi-LDPE samples is notably similar.

TABLE 4
High Temperature GPC results

| Sample | Oxidant | Time | | Mw | Mn | PDI |
|---|---|---|---|---|---|---|
| Oxi-LDPE_1 | H₂O₂ | 24 | h | 4.92E+04 | 8.6E+03 | 5.7 |
| Oxi-LDPE_2 | TBHP | 8 | h | 4.16E+04 | 6.1E+03 | 6.9 |
| Oxi-LDPE_3 | TBHP | 24 | h | 5.94E+02 | 4.8E+02 | 1.2 |

GPC analysis (FIG. 32c, Table 4) of the oxi-LDPE samples revealed that their molecular weights are also strikingly similar, thereby implying that the initial step of oxygen incorporation into the LDPE matrix primarily occurs via C—H bond cleavage, regardless of whether TBHP or H₂O₂ is employed as the oxidant. However, a prolonged reaction with TBHP beyond 8 hours leads to further oxidation of LDPE through β-scission of C—C bonds, resulting in the formation of small oxygenated oligomers. In contrast, when H₂O₂ is utilized, the reaction predominantly happens through C—H bond cleavage.

In both scenarios, the primary oxidation products are generated by C—H bond cleavage. The significant variance in reaction rates could be attributed to the higher affinity of LDPE for the TBHP solution compared to the aqueous H₂O₂ solution. Although both oxidants are solubilized in water, TBHP may more readily integrate into the hydrophobic polymer matrix, thus exhibiting an ostensibly enhanced reactivity.

Without being bound by a particular scientific theory, polyketone-like materials can be synthesized by fine-tuning the choice of oxidant and the reaction duration.

### Tenth Example: Use of Different Types of Catalysts and Reaction Media

### 1. Oxidation Catalyzed by Iron [Fe(III)SO4]

Fenton oxidation and Fenton like oxidation have been reported to degrade microplastics. The general Fenton-like reaction of Fe(III) salts with TBHP which generates alkoxy and peroxy radicals is shown in Scheme 2.

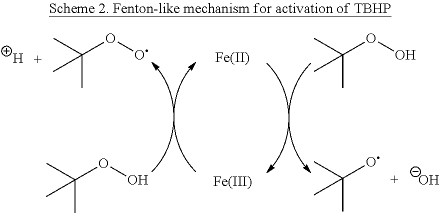

LDPE (0.05 g) was heated with TBHP (1 mL, 5.5 Min n-decane) in 0.5 mL of decane at 100° C. for 24 h in the presence of the Fe(III) catalyst (1 wt %). The IR of the oxi-LDPE product confirms the presence of C═O stretching typical of ketones, FIG. 33a. This oxi-LDPE, slightly soluble in CHCl₃, was analyzed by GPC. The results appear to show significant chain cleavage (FIG. 33b) and a yield of the soluble fraction of ca. 40%. However, high temperature GPC will be needed to quantify the extent of C—C cleavage properly.

### 2. Oxidation Catalyzed by MnBr₂

Inspired by a recent report on the use of an AMOCO-like process for the oxidative depolymerization of mixed plastic waste [2], we explored LDPE oxidation with peroxides using MnBr₂ as the catalyst. After an initial optimization of reaction conditions, the best conditions involved LDPE (0.05 g) reacting at 110° C. for 24 h with either TBHP (1 mL, 70 wt % in H₂O)+MnBr₂ (2.5 wt %), or H₂O₂ (0.5 mL, 30 wt % in H₂O)+MnBr₂ (2.5 wt %).

In both reactions, oxi-LDPE was recovered as a soft, white solid. The products were analyzed by IR (FIG. 34) and ¹H NMR (FIG. 27a, FIG. 35). Both IR spectra have a carbonyl peak at 1712 cm⁻¹. Its relative intensity is stronger when the oxidant is TBHP, compared to H₂O₂. In the ¹H NMR spectra both in FIG. 27a and FIG. 35, signals appear for methylene (ca. 2.38 ppm) and methyl (ca. 2.16 ppm) protons located a to internal and methyl ketone chain ends. In the ¹H NMR spectra in FIG. 27a, protons located in B to an ester group are detected. From the relative integrated peaks we can state that, in general, the amount of internal ketones exceeds that of terminal methyl ketones, and the ratio is higher when the oxidant is TBHP relative to H₂O₂. The latter finding is consistent with TBHP causing more extensive C—C bond cleavage than H₂O₂, possibly representing a way to tune the target molecular weight of oxi-LDPE.

In the ¹³C NMR spectra in FIG. 36 the signal at ca.42 ppm is related to secondary carbon located in a position to an internal ketone.

### 3. Oxidation Catalyzed by Ti(OiPr)₄

Ti complexes catalyze the oxidation of olefins by peroxides. Specifically, Ti(OPrᵢ)₄ (Titanium isopropoxide, or Ti(OiPr)₄) catalyzes the oxidation of olefins by TBHP in solution at room temperature [3]. In this section, we decided to explore homogeneous Ti catalysts for the oxidation of LDPE.

LDPE (0.05 g) was combined with a solution of Ti(OiPr)₄ (1 wt %) and TBHP (1 mL, 5.5 M in n-decane) for 24 h at 100° C. The oxi-LDPE product, recovered as a pale yellow solid, was analyzed by IR and ¹H NMR. The IR spectrum (FIG. 37) shows a strong ketone peak at 1712 cm⁻¹. Its breadth and lack of symmetry suggest an overlapping ester peak. The ¹H NMR spectrum was first recorded in CDCl₃, in which only a portion of the solid product was soluble. The presence of esters was confirmed by the singlet at 1.45 ppm. Other peaks at 2.4 and 2.1 ppm are assigned to methylene and methyl protons located in a to internal and methyl ketone chain ends. The sharp peak at ca. 2.16 ppm, assigned to methyl protons adjacent to a terminal ketone chain end, indicates C—C bond cleavage on the PE backbone. The peak integrations for the terminal methyl and methylene protons reveal that the ketones are located mainly on the PE backbone. In fact, the integral for the protons in a to internal ketones is five times higher in respect to the integral related to the methyl protons in a to ketone chain ends. ¹H NMR peaks characteristic of aldehydes, ethers, and carboxylic acids were not observed.

To better solubilize the oxi-LDPE, NMR experiments were also conducted in a 1:1 mixture of 1,1,1,3,3,3-Hexafluoroisopropanol (HFIP) and C₆D₆. The presence of methylene and methyl protons located a to internal and chain end ketone groups was confirmed, but the signals seem to overlap, causing problems for the integration. In addition, a peak at 1.81 ppm of unknown origin is present.

These results reveal a majority of internal ketones, compared to oxidation with TBHP at 150° C. which gave mostly terminal ketones.

### 4. Oxidation Catalyzed by Ti-Sylopol

Titanium silicalite (TS-1) was reported to catalyze the oxy-functionalization of alkanes to alcohols and ketones by aqueous H₂O₂[4]. On this basis, we decided to explore the heterogeneous Ti catalysts for the oxidation of LDPE.

Since the micropores of TS-1 are difficult for macromolecules such as LDPE to access, we synthesized a Ti-coated mesoporous silica catalyst by the reaction of TiCl₄ with Sylopol at room temperature. After reaction, the material was calcined at 500° C.

LDPE (0.05 g) and H₂O₂ (0.5 mL, 30 wt % in H₂O) were allowed to react at 100° C. for 24 h in the presence of the Ti/silica catalyst (10 wt %). After 24 h, the spent solid catalyst was separated from the reaction mixture via centrifugation and oxi-LDPE product was recovered as a white solid. Its IR spectrum is shown in FIG. 38 (orange line) and it confirms the presence of C═O stretching typical of ketones. However, the carbonyl peak has a lower intensity compared to the oxi-LDPE obtained in the reaction with TBHP catalyzed by Ti(OPrⁱ) 4 (FIG. 38, blue line).

The reactivity obtained in the heterogenous phase experiment is promising. However, the product is not soluble in either CHCl₃ or in HFIP/C₆H₆ (1/1). A more suitable solvent and reaction conditions (oxygen source, reaction time) may be used.

### 5. Supercritical CO₂ as a Reaction Medium

In recent literature, O₂ dissolved in supercritical CO₂ (scCO₂) was shown to be effective in thermal oxidation of polyethylene at 140° C., FIG. 39 [5].

After 24 h, the products were ethylene oligomers (whose oxygen content was not specified) as well as small molecules such as acetic, formic and propionic acids. Based on this, we decided to use scCO₂ as reaction medium in our system, with H₂O₂ as the oxidant instead of O₂ for safety reasons, and because it is likely to be effective at lower reaction temperatures.

To achieve supercritical conditions, a Parr reactor was connected to a high pressure CO₂ tank.

A 30 mL Parr reactor was loaded with LDPE (50 mg) and H₂O₂ (1 mL, 30 wt % in H₂O), then pressurized with CO₂ (1058 psi). The reaction was conducted at 110° C. After 24 h, the reactor headspace was analyzed with GC-MS. The only hydrocarbon product detected was CH₄, in a trace amount. The IR spectrum of the recovered white solid is shown in FIG. 41.

The peak at 1714 cm⁻¹ indicates the presence of a carbonyl group in the oxi-LDPE product, however, its low intensity suggests a limited incorporation of oxygen. Nevertheless, the presence of scCO₂ enhanced the extent of oxidation, since no carbonyl signal was detected when the same reaction was conducted without scCO₂. We consider this process to be a promising candidate for further studies.

### Example Process Steps

FIG. 41 is a flowchart illustrating a method of synthesizing a wax or polyketone, according to one or more embodiments.

Block 4100 represents reacting of a polyolefin with a peroxide in a presence of a solvent under conditions including a temperature below 200° C., wherein at least one of carbon-carbon bonds or carbon-hydrogen bonds in the polyolefin are cleaved via oxidation by the peroxide so as to form a polyketone or a wax comprising an oxidized polyolefin.

The step may comprise contacting a peroxide, or multiple peroxides, and a polyolefin, or multiple polyolefins (e.g., polypropylene, polyethylene, or polystyrene) with a solvent (the solvent can be a co-solvent), or obtaining a composition comprising the solvent and the peroxide and/or the polyolefin. In one or more examples, the step comprises obtaining untreated plastic waste (comprising the polyolefin or polyolefins) and contacting the plastic waste (comprising the polyolefin and optionally and any additives impurities, other polyolefins) with the solvent, e.g., so as to form a solution. In one or more examples, the polyolefin is contacted with a solution that already contains dissolved peroxide. In other examples, the solution may comprise a homogeneous solution of the peroxide and the polyolefin.

In one example, the step comprises selecting a weight percentage of the peroxide in the solution relative to a mass of the polyolefin so as to achieve a desired molecular weight of wax comprising the oxidized polyolefin. A lesser weight percentage of the peroxide results in a higher molecular weight of the oxidized polyolefin. In one or more examples and in accordance with the experimental data presented herein, 10 wt %-200 wt %, or 60 wt %-2000 wt % of the peroxide in the solution, relative to a mass of the polyolefin may be used. In one or more further examples, the mole ratio of the monomer unit in the polyolefin to peroxide ranges from ca. 0.1 to ca. 10, or 0.5 to ca. 20 (wherein a lower value means a larger amount of peroxide; for the data in FIG. 19, we used PE and H₂O₂, and the mole ratio of monomer and peroxide in this experiment is ca. 2)

In some examples, various solvents can be used including, but not limited to, any hydrocarbon based solvent (e.g., decane, nonane, cyclohexane, methylcyclohexane, isooctane, toluene and p-xylene) capable of dissolving the polyolefin as oxidation proceeds.

The peroxide may comprise, but is not limited to, hydrogen peroxide, lithium peroxide, sodium peroxide, calcium peroxide, barium peroxide, zinc peroxide, or an organic peroxide (e.g., cumene hydroperoxide, dicumyl peroxide, tert-butyl hydroperoxide, Di-tert-butyl peroxide, lauroyl peroxide, 2-butanone peroxide, benzyl peroxide).

The temperature at which the polyolefin dissolves in the solvent may depend on the polyolefin, the solvent, the oxidation, and the amount of polyolefin. In one or more examples, 150° C. is the lower bound of the temperature used to dissolve PP in decane. However, by increasing the solvent amount and decreasing the PP amount, the temperature at which the polyolefin is soluble may be decreased (e.g., to 120° C.). Moreover, under some conditions, PE or PP may be dissolved at temperatures lower than 150° C., e.g., 80° C. (for PE in 1,2-dichloroethane) or 85° C. (for PP in cyclohexane).

The conditions (including temperature range) under which the oxidation reaction (and/or dissolving) in block 4100 are performed may be selected depending on desired oxidation rate, dissolution, and/or decomposition of the reagent(s). In some examples, the oxidation reaction is performed in a temperature range having a lower bound (e.g., 100° C.) enabling a rate of the oxidation reaction above a desirable threshold, and an upper bound (e.g., 180-200° C.) above which the oxidation rate does not increase significantly, and/or such that the concentration of peroxide is decreased below an undesirable level (due to the increased rate of peroxide decomposition at higher temperatures to), and/or such the peroxide source becomes explosive or other uncontrollable. For example, some peroxides can decompose at temperatures above 200° C. to side products which prevent the desired oxidation and cleavage of polyolefins (type 1 decomposition), or to radical species which can still lead to polyolefin oxidation and cleavage (see e.g., eq. 1-3 in Appendix A of the priority application U.S. Provisional Application Ser. No. 63/433,849., type 2 decomposition). Thus, the upper bound may be selected to avoid type 1 decomposition that prevents oxidation and/or to avoid overly rapid decomposition/oxidation involving the radical species that lead to uncontrolled reactions or undesired side reactions (type 2 decomposition). Since most of the decomposition/oxidation reactions are exothermic, overly rapid reactions at temperatures above 200° C. and involving the radicals may lead to thermal runaway or even explosion in extreme cases. Thus, in one or more examples, the temperature is in a range of 100 and 200° C.

Without being bound by a particular scientific theory, the polyolefin may dissolve in the solvent prior to and/or during the oxidation reaction.

In one or more examples, the peroxide is slowly added to the solution or added to the solution in multiple steps so as to maximize reaction of the peroxide with the polyolefin and avoid excess peroxide that decomposes prior to reaction.

In one or more examples, an amount of the peroxide, the solvent, and a reaction time of the reaction are selected so that the wax products have a number average molecular weight (Mₙ) in a range of 500-5000 g/mol with a polydispersity in a range of 1.2-2.5 or 1.5-2.5.

In one or more further examples, the amount of polyolefin and peroxide are modulated to control at least one of the saponification number or acid number of the resulting oxidized polyolefin.

A catalyst can be added to help decompose the oxidizer (e.g., peroxide). The composition of the oxidizer, the amount of the oxidizer, the reaction temperature, and/or the duration of the reaction can then be selected to influence the selectivity of the reaction toward polyketone or a wax as a product. Example catalysts include, but are not limited to, catalyzing the reaction using [Fe(III)SO₄] or MnBr₂. In a catalyzed embodiment at a certain reaction temperature, wherein the peroxide is hydrogen peroxide and the solvent is water, the reaction forms the polyketone. In a catalyzed embodiment at a certain reaction temperature, wherein the peroxide is TBHP and the solvent is water, the reaction forms the wax (e.g., having a molecular weight of 500 or less or 1000 or less.

Block 4102 represents the end result, a composition of matter for an oxidized polyolefin formed by oxidizing the polyolefin. Example compositions of matter include, but are not limited to, the following examples.

1. A composition of matter, comprising an oxidized polyolefin (polystyrene, polyethylene, and/or polypropylene, or the mixture thereof) having at least one of:
a number-averaged molecular weight in a range of 500-5000 g/mol with optionally a dispersity in a range of 1.2-2.5;
an oxygen content characterized by a saponification number in a range of 30-200 or 30-150, wherein the saponification number is the amount of potassium hydroxide in milligrams required to saponify one gram of the oxidized polyolefin;
an oxygen content characterized by an acid number in a range of 15-100, wherein the acid number is the amount of potassium hydroxide in milligrams required to neutralize 1 g of the oxidized polyolefin dissolved in xylene,
a total oxygen content of 3-15 wt. % (e.g., 3 wt. %≤oxygen content≤15 wt %) relative to the mass of the oxidized polyolefin,
a ketone oxygen content which is greater than the sum of the ester and carboxylic acid contents, or
an alcohol oxygen content of 1-4 wt %.

2. The composition of matter of example 1, wherein the oxidized polyolefin is characterized by a saponification number greater than that for a wax formed by oxidation of the polyolefin in a molten form (melt oxidation), oxidation of the polyolefin in an aqueous dispersion, or oxidation of the polyolefin in a solid form.

3 The composition of matter of example 1 or 2, wherein the oxygen content is 2-5 times greater than in the oxidized polyolefin formed by oxidation of the polyolefin in a molten form (typically 3-4 wt %).

4. The composition of matter of example 1 or 2 or 3, wherein the oxidized polyolefin has a melting point in a range of 70-120° C. (e.g., as measured by DSC).

5. The composition of matter of example 1, wherein the oxidized polyolefin is characterized by a dispersity narrower than that for a wax formed by oxidation of the polyolefin in a molten form (melt oxidation), oxidation of the polyolefin in an aqueous dispersion, or oxidation of the polyolefin in a solid form.

6. The composition of example 1, comprising the oxidized polyolefin wherein, according to the intensities of the carbonyl peaks in the IR spectra, the ketone amount is higher than the ester and carboxylic acid amounts.

7 The composition of matter of example 1, wherein the oxidized polyolefin comprises oxi-PE wherein, according to acid number and saponification number, the amount of carboxylic acid amount is comparable to the ester amount.

8. The composition of matter or example 1, wherein the oxidized polyolefin comprises oxi-iPP having an amount of acid higher than the amount of the ester or oxi-iPP having the amount of ester higher than the amount of acid. Thus, the amount of ester and acid can be controlled based on reaction conditions.

9. The composition or method of any of the examples, wherein the oxidation is catalyzed, e.g., using [Fe(III)SO₄] or MnBr₂, or a transitional metal based catalyst (e.g., containing nickel or Cr, Mₙ, Co, Ti) as the active agent, e.g., combined with bromine, or using supercritical CO₂ as reaction medium. 10. The composition or method of any of the examples, wherein the solvent, e.g., organic solvent-dissolves the catalyst and plastic at the reaction temperature, to allow for a more homogeneous mixture and oxidation. In one or more embodiments when the solvent is H₂O and the polymer is not dissolved at the beginning of the reaction, the reaction mixture appears homogeneous after several hours (e.g., >5).

11. The composition of matter of any of the examples, wherein the organic solvent and amount of solvent are selected to dissolve the plastic and/or catalyst and oxidizer, while reducing the reaction of the solvent with the oxidizer (performing a trade-off).

12. In one embodiment, polyketone is formed using peroxide (oxidizer) and water (solvent) after at least 24 hours at a reaction temperature of 100-200 degrees. Performing the reaction at a higher temperature may shorten the reaction time.

13. In one embodiment, selection between polyketone and wax products for oxidation of LDPE is as follows. Either hydrogen peroxide for at least 24 h or TBHP for up to 8 hours can be used as oxidants make polyketone by C—H cleavage. As reaction time is increased beyond 8 hours for TBHP, higher oxidation of TBHP allows C—C cleavage to form waxes (for longer times, lower MW wax is obtained).

14. A polyketone comprising an oxygen content larger than 4 wt % (e.g., 4 wt %≤oxygen content≤4.2 wt. %, 4 wt %≤oxygen content≤5 wt. %, 4 wt %≤ oxygen content≤5.5 wt. %, e.g., 4 wt %≤oxygen content≤6 wt. %; wherein a content of ketones is greater than a content of the esters.

15. The polyketone of embodiment 14, wherein the polyketone comprises less than 15% molecular weight change as compared to the LDPE form which the polyketone is oxidized.

16. The polyketone of embodiment 14-15 synthesized by the method of any of the catalyzed embodiments wherein the polyolefin comprises LDPE.

17. The polyketone of any of the embodiments 14-16 of the structure:

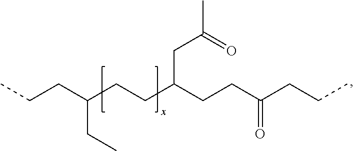

18. The polyketone of any of the embodiments 14-17 comprising and a random distribution of ketones.

19. The polyketone of any of the embodiments 14-18 comprising non-alternating ketone groups.

20. The polyketone of any of the embodiments 14-19, wherein an amount of oxidation and/or the temperature are controlled (e.g., increased) to increase the oxygen content within the limit that increased oxidation and temperature increase C—C cleavage so as to lower polymer molecular weight, therefore the oxidation may be increased so long as the molecular weight is not reduced below a predetermined threshold level.

21. The polyketone of any of the embodiments 14-20, wherein (e.g., the oxidation and/or the reaction temperature and/or the reaction duration are such that) the oxygen content and molecular weight of the polyketone are within controlled predetermined ranges and/or the molecular weight is not reduced by more than 15% as compared to the molecular weight of the polyolefin (e.g., LDPE, PP, PE) from which the polyketone was oxidized.

22. The polyketone of any of the embodiments 14-19, wherein the oxygen content is 4 wt %≤oxygen content≤4.2 wt. %, 4 wt %≤oxygen content≤5 wt. %, 4 wt %≤oxygen content≤5.5 wt. %, e.g., 4 wt %≤oxygen content≤6 wt. % and the molecular weight is not reduced by more than 15% as compared to the molecular weight of the polyolefin from which the polyketone was oxidized.

23. The polyketone or wax of any of the embodiments 1-22, wherein the wt % of the oxygen content is assuming the products only consist of carbon, hydrogen, and oxygen, carbon and hydrogen contents were obtained using an elemental analyzer and the amount of oxygen in the polyketone was calculated by subtracting the carbon and hydrogen content from 100 wt %.

24. The polyketone or wax of any of the embodiments 1-22, wherein the acid number, saponification number, alcohol content, or oxygen content is determined using the methods described in under the heading “3. Characterization methods for oxidized PP and PE” on pages 36-37 of this application.

25. The method or composition of any of the embodiments 1-14, wherein various reaction parameters (e.g. amount of oxidant, temperature, reaction time and solvent) affecting the oxygen content and molecular weight of the polyketones or wax are selected (e.g., to control the fraction of C—H cleavage and C—C cleavage) so as to form polyketones and wax with controlled oxygen content and molecular weight.

26. The method or composition of embodiment 25, wherein increasing the oxidation increases both C—H and C—C cleavages which leads to lower polyketone molecular weight.

Block 4104 represents utilizing the composition of matter in an application, e.g., as an additive, lubricants, adhesive, or coating reagent.

### Example Reactor

In typical examples, the reactor for synthesizing oxidized polyolefin from plastic waste comprises a vessel (e.g., pressure vessel) for containing a solution comprising peroxide and the polyolefin at least partially dissolved in a solvent. In one or more embodiments, the vessel is a pressure vessel or closed vessel (e.g., glass pressure vessel) so that TBHP cannot escape from the reactor (the boiling point of TBHP is only 89° C. at 1 atm [4], thus a closed vessel can be used to prevent TBHP escaping at the reaction temperature range of 100-200° C.). In another example, the vessel comprises an open vessel coupled to a condenser.

The reactor further comprises a temperature sensor, heater, and temperature control system (e.g., cooler and/or heater) coupled to the pressure vessel for regulating a temperature of the solution. One or more openings in the pressure vessel are used for transferring at least one of the solution or the solvent into the pressure vessel. A control circuit (e.g., computer controller) is used for controlling the temperature and reaction time of an oxidation reaction wherein carbon-carbon bonds in the polyolefin are cleaved via oxidation by the peroxide so as to form one or more waxes comprising an oxidized polyolefin. The one or more openings are further used for removing the oxidized polyolefin from the pressure vessel.

The reactor can be configured to perform the method (or synthesize the composition) of any of the embodiments 1-26 or the method of FIG. 41. The reactor can include a computer/controller/circuit to control the amounts of oxidant, temperature, and reaction time.

### Advantages and Improvements

Conventional wax materials are produced in a similar way compared with polyolefin production, using ethylene/propene as monomer units and a catalyst to link them together. In addition, a polar form of waxes is typically obtained from the molten form of polyethylene with dioxygen as an oxygen source. In contrast, we developed a process for the production of waxes by converting plastic wastes (PE, PP, PS, and even mixture of those) by using hydroperoxide sources without additional catalysts, which makes this process more affordable in industrial applications. Owing to the ease of controlling the molecular weight with narrow dispersity, oxidized waxes derived from plastic wastes can be used in various applications such as lubricants, adhesives, paint additives, dispersant, resin modifier etc.

The similar process can also be used to produce polyketones by catalytic oxidation of LDPE with controlled reaction solvent, time, temperature and oxidant loading.

### Supplementary Information: Materials and Methods Used for Obtaining the Data in Examples 1-8

### 1. Chemicals

Two isotactic polypropylenes (Mₙ 54,000 g/mol, Ð=6.5 (SKU-427861) and Mₙ 8,300 g/mol, Ð=2.8 (SKU: 428116)), amorphous polypropylene (Mₙ 6,700 g/mol, =4.1 (SKU-428175)), high-density polyethylene (SKU-547999), low-density polyethylene (SKU-428043), ultra-high molecular weight polyethylene (SKU-429015), tert-butyl hydroperoxide solution (5.5 M in decane), n-decane (anhydrous, ≥99%), nonanal (95%), meta-chloroperoxybenzoic acid (≤77%), 4-methyl-2-pentanone (≥98.5%), benzaldehyde (≥98.5%), methyl 10-undecenoate (96%), 3-methylpentane (≥99%), squalane (96%), 2-methoxyethanol (99.9%), dihexyl ketone (97%) and lauric acid (≥98%) were purchased from Sigma Aldrich. Chloroform-D (99.8%) was purchased from Cambridge Isotope Laboratories. Ethanol (200 proof) was obtained from Rossville Gold Shield. Xylene was purchased from MP Biomedicals. Potassium hydroxide (P250-500) was obtained from Fisher Chemical. Hydrochloric acid (36.5-38.0 wt %) was obtained from Millipore Corporation, Billerica, MA. All chemicals were used as-received.

### 2. TBHP-Mediated Oxidation of Polyolefin and Model Chemicals

0.400 g PP and 0.5-1.5 mL TBHP (5.5 M in n-decane) solution were added to a 15 mL glass pressure reactor, and the reactor opening was closed with a bushing and Kalrez O-ring. The glass pressure reactor was placed into an oil bath at desired temperatures and reaction times. After the reaction, the glass pressure reactor was cooled down to room temperature using a water bath. The solid product was transferred to a glass vial with the assistance of ethanol. Ethanol, decane, unreacted TBHP, and decane oxygenates were removed by Rota Vap (130 mbar, 30° C., ca. 20 min) followed by evacuation (0.1 mTorr, RT, overnight), then drying at 70° C. for 8 h. The last step did not change the chemical composition of oxidized products, but served only to remove residual decane and decane oxygenates.

For the PE oxidative cleavage reaction, 0.267 g of PE was added to the glass pressure reactor containing TBHP (5.5 M in n-decane) solution. The subsequent procedure is the same with the PP oxidative cleavage reaction.

For the model chemicals of PP, 3-methylpenetane (3.9 mmol) or squalane (0.96 mmol) was added to the glass pressure reactor containing TBHP solution. The reactor opening was closed with a bushing and Kalrez O-ring. The reactor was placed in the oil bath at 150° C. for 24 h. For the oxidation of unbranched model hydrocarbon, TBHP (5.5 M in n-decane) solution was heated at the same condition. For the GC analysis of liquid-phase products, the products were diluted in ethanol. For the NMR analysis, the products were diluted in CDCl₃.

For the analysis of gas-phase products obtained from the oxidation of polyolefins or model chemicals, the glass reactor with a side arm was used to collect the gas-phase products. After the reaction, the reactor was cooled down to RT, and the outlet of the side arm was fitted with a rubber septum. The gas-phase products were extracted with a gas-tight syringe for the GC-FID measurement.

### 3. Characterization Methods for Oxidized PP and PE

Gel permeation chromatograph. For the preparation of room temperature Gel permeation chromatography (RT-GPC), 4-6 mg of oxidized PP and 2.0 mL chloroform with 0.25% triethylamine (TEA) were added to a glass vial. The glass vial was placed in an oven at 80° C. for a few minutes to completely dissolve the products. After the vial is cooled down to RT, the solution was passed through 0.45 μm filter for GPC measurement. GPC analysis was done on a Waters Alliance HPLC system with a 2690 separation module. Sample solution was passed through 2 Tosoh TSKgel SuperHZM-N and guard (MW linear range 200-700,000 g/mole). The analysis was conducted by using a Water 2410 differential refractometer and a Waters 2998 photodiode array detector. A calibration curve was created with polystyrene (PS) standards ranging from 162 to 1,044,000 g/mole.

The high-temperature GPC equipment (HT-GPC) was used to obtain the molecular weights of oxidized PPs that are not dissolved in chloroform, oxidized PEs, initial PP and PE provided from Sigma Aldrich, and the post-consumer iPPs and HDPE. Samples were wrapped in a 26 μm metal mesh filter, prepared to a 0.1 wt % solution in o-Dichlorobenzene (with 0.5 g/L butylated hydroxytoluene), and then dissolved and filtered at 135° C. for 30 minutes. The experiment was performed on an EcoSEC HLC-8321GPC/HT (Tosoh Bioscience) equipped with a TSKgel guard column HHR-HT (7.5 mm× 7.5 cm) and a TSKgel GPC column (GMHHR-H; 300 mm×7.8 mm) calibrated with monodisperse polystyrene standards.

The molecular weights obtained based on the polystyrene standard were converted for PP and PE standards using the eq (S1).

$$log {M}_{x} = ( \frac{1}{1 + {a}_{x}} ) log \frac{{K}_{PS}}{{K}_{x}} + ( \frac{1 + {a}_{PS}}{1 + {a}_{x}} ) log ( {M}_{PS} ) \qquad ( S 1 )$$

M_{PS} is the molecular weight obtained using the PS standard. K_{PS} and α_{PS} are Mark-Houwink constants for polystyrene. Kₓ and α_{PS} are Mark-Houwink constants for PP or PE, and Mₓ is the converted molecular weight. Previously reported values for these constants are used.¹⁻³ For the mixture of oxidized PP and PE, the molecular weights based on the PP standard were reported in the main manuscript. The molecular weights converted by PE standards are represented in Figure S39.

Gas chromatography. The products in the liquid phase after the oxidation reactions and model compound reactions were qualitatively analyzed on a Shimadzu GC-2010 gas chromatograph equipped with an Agilent DB-1 capillary column (dimethylpolysiloxane, 30 m×0.25 mm× 0.25 μm) coupled to a QP2010 Mass spectrometer. The injector and detector temperatures were 250° C. The temperature ramp programs were 60° C. (hold 2 min), ramp 15° C./min to 270° C. (hold 35 min).

The products in the gas phase were also analyzed on a Shimadzu GC-2010 gas chromatograph equipped with a capillary column (Supelco Alumina Sulfate plot, 30 m×0.32 mm) and a flame ionization detector (FID). Relative carbon response factors were assumed to be 1.0. The injector and detector temperatures were 200° C. The temperature ramp program was: 90° C. (hold 5 min), ramp 10° C./min to 150° C. (hold 20 min).

NMR spectroscopy. Oxidized PP Samples for the NMR measurements were prepared by combining ca. 5 mg of oxidized samples with CDCl₃ 1.0 mL in a glass vial. The glass vial was placed in an oven at 80° C. for a few mins. After cooling to room temperature, ca. 700 μL of the solution was used for the collection of ¹H NMR spectra using an 800 MHz SB Bruker Avance spectrometer. ¹³C, ¹³C DEPT-135, 2D ¹H-¹³C HSQC, and HMBC NMR spectra are recorded on the Bruker Avance NEO 500 MHz spectrometer. For the oxidized PE samples, the NMR measurement was conducted at 50° C. Chemical shifts are reported with respect to internal solvent (CDCl₃, δ(¹H) 7.26 ppm and δ(¹³C) 77.5 ppm, respectively). The obtained spectra were analyzed using MestReNova (v14.2.0, Mestrelab Research S. L.).

IR spectroscopy. The Fourier transform-infrared (FT-IR) spectra of samples were obtained using a Thermo Scientific Nicolet iS10 FTIR spectrometer equipped with a Smart Orbit (Diamond) attenuated total reflectance (ATR) accessory. A resolution of 4 cm⁻¹ and 32 scans per sample were used.

Differential Scanning calorimetry (DSC). DSC measurements were performed on a TA Instruments DSC 2500. Each polymer sample (ca. 3 mg) was placed in a Tzero aluminum pan. DSC measurements were taken at a heating and cooling rate of 10° C./min. The melting temperature (Tₘ) was obtained from the second heating cycle.

Thermogravimetric analysis (TGA). TGA measurements were performed under the flow of air on a TA Instrument TGA 5500 thermogravimetric analyzer in the temperature range from 50 to 300° C. (ramp rate: 10° C. min-1).

Viscosity. Viscosity values of oxidized products were measured using ARES-G2 Rheometer with 25 mm plate in N₂ atmosphere at 140° C.

Acid number (AN). Oxidized product 0.5 g and xylene 25 mL are added to a round flask, and heated to 75° C. at 100 rpm. After the product is dissolved, ethanol 12 mL is slowly added to the flask. The solution is titrated with 0.1 M KOH 2-methoxyethanol solution and phenolphthalein indicator. The volume of added KOH solution is denoted as V₁. The AN is calculated by the eq S2, where M₁ is the molarity of KOH, and m is the mass of the sample in gram.

$$AN = \frac{{V}_{1} \times {M}_{1} \times 56.1}{m} \qquad ( S 2 )$$

Saponification number (SN). Oxidized product 0.5 g and xylene 10 mL are added to a round flask fitted with a condenser, and the flask is heated to 100° C. until the oxidized product is dissolved. After cooling down the flask, 15 mL of 0.1 M KOH 2-methoxyethanol solution is added, and the solution is heated at 130° C. for 2 h at 100 rpm. After the temperature of the flask is set to 60° C., the solution is titrated with 0.3 M HCl aqueous solution with the phenolphthalein indicator. The added HCl solution is denoted as V₂. The titration is conducted without adding oxidized products, and the volume of HCl solution for the titration is denoted as V₃. The SN number is calculated by eq S3, where M₂ is the molarity of HCl solution and m is the mass of the sample used in gram.

$$SN = \frac{( {V}_{3} - {V}_{2} ) \times {M}_{2} \times 56.1}{m} \qquad ( S 3 )$$

The ester number (EN) is obtained by subtracting AN from SN.

Alcohol content. The mass percent of oxygen due to the presence of alcohol was obtained by measuring the increased ester number after acetylation reaction. To consume alcohol groups via the acetylation reaction, oxidized product 60 mg and acetyl chloride 4.4 mmol were added to a glass pressure reactor containing CHCl₃ 12 mL. The reaction was conducted at 70° C. for 15 h. After the reaction, the reactor was cooled down to RT, and the solvent and remaining acetyl chloride in the solution was removed by using Rota Vap (50° C., 350 mbar). The product was further dried under evacuation (0.2 mTorr) for 8 h. Xylene 4 mL and 0.025 M KOH 2-methoxyethanol 13 mL were added, and the solution was heated at 130° C. for 2 h. After cooling to 60° C., titration was conducted with 0.02 M HCl aqueous solution with the phenolphthalein indicator to obtain a saponification number. The increased ester number which corresponds to the amount of reacted alcohol is obtained by eq S4.

Increased EN=SN of acetylated product−EN before the reaction-2×(AN before the reaction) (S4)

Oxygen content. The mass fraction of oxygen was obtained assuming the products only consist of carbon, hydrogen, and oxygen. Carbon and hydrogen contents were obtained using EAI CE-440 elemental analyzer (EAI Co.Ltd). The amount of oxygen in the oxidized product was calculated by subtracting the carbon and hydrogen content from 100 wt %.

### REFERENCES FOR EXAMPLES 1-8

The following references are incorporated by reference herein
[1] Renewable ketone waxes with unique carbon chain lengths and polarities. (WO 2019/070422 A1)
[2] Green Chemistry, 2021, 23, 7137-7161
[3] In Ullmann's Encyclopedia of Industrial Chemistry; Wiley-VCH Verlag GmbH & Co. KGaA, Ed.; Wiley-VCH Verlag GmbH & Co. KGaA: Weinheim, Germany, 2015; pp 1-63
[4] https://pubchem.ncbi.nlm.nih.gov/compound/Tert-butyl-hydroperoxide #section=Boiling-Point

### REFERENCES FOR NINTH EXAMPLE

The following references are incorporated by reference herein.
(1) Adams, J. H. Analysis of the Nonvolatile Oxidation Products of Polypropylene I. ThermalOxidation. J Polym Sci A1 1970, 8 (5), 1077-1090. https://doi.org/10.1002/POL.1970.150080505.
(2) Pérez, E.; Fraga-Dubreuil, J.; García-Verdugo, E.; Hamley, P. A.; Thomas, M. L.; Yan, C.; Thomas, W. B.; Housley, D.; Partenheimer, W.; Poliakoff, M. Selective Aerobic Oxidationof Para-Xylene in Sub- and Supercritical Water. Part 2. The Discovery of Better Catalysts. Green Chemistry 2011, 13 (9), 2397-2407. https://doi.org/10.1039/C1GC15138J.
(3) Gardette, M.; Perthue, A.; Gardette, J. L.; Janecska, T.; Földes, E.; Pukánszky, B.; Therias, S.Photo- and Thermal-Oxidation of Polyethylene: Comparison of Mechanisms and Influence ofUnsaturation Content. Polym Degrad Stab 2013, 98 (11), 2383-2390.
https://doi.org/10.1016/J.POLYMDEGRADSTAB.2013.07.017.
(4) A. Sen, Adv. Polym. Sci. 73-74, 125 (1986).

### REFERENCES FOR TENTH EXAMPLE

The following references are incorporated by reference herein
(1) Hu, K.; Zhou, P.; Yang, Y.; Hall, T.; Nie, G.; Yao, Y.; Duan, X.; Wang, S. Degradation of Microplastics by a Thermal Fenton Reaction. ACS ES and T Engineering 2022, 2 (1), 110-120.
https://doi.org/10.1021/ACSESTENGG.1C00323/ASSET/IMAGES/LARGE/EE1C00 323_0_008.JPEG.
(2) Sullivan, K. P.; Werner, A. Z.; Ramirez, K. J.; Ellis, L. D.; Bussard, J. R.; Black, B. A.; Brandner, D. G.; Bratti, F.; Buss, B. L.; Dong, X.; Haugen, S. J.; Ingraham, M. A.; Konev,
M. O.; Michener, W. E.; Miscall, J.; Pardo, I.; Woodworth, S. P.; Guss, A. M.; Román-Leshkov, Y.; Stahl, S. S.; Beckham, G. T. Mixed Plastics Waste Valorization through Tandem Chemical Oxidation and Biological Funneling. Science (1979) 2022, 378 (6616).
https://doi.org/10.1126/SCIENCE.ABO4626/SUPPL FILE/SCIENCE.ABO4626 DA TA_S 1.ZIP.
(3) Fujiwara, M.; Xu, Q.; Souma, Y.; Kobayashi, T. Oxidation of Alkanes by TBHP in thePresence of Soluble Titanium Complexes. J Mol Catal A Chem 1999, 142 (1), 77-84. https://doi.org/10.1016/S1381-1169 (98) 00284-2.
(4) Huybrechts, D. R. C.; Bruycker, L. De; Jacobs, P. A.; Huybrechts, D. R. C.; Bruycker, L. De; Jacobs, P. A. Oxyfunctionalization of Alkanes with Hydrogen Peroxide on Titanium Silicalite. Natur 1990, 345 (6272), 240-242. https://doi.org/10.1038/345240A0.
(5) Elmanovich, I. V.; Stakhanov, A. I.; Kravchenko, E. I.; Stakhanova, S. V.; Pavlov, A. A.; Ilyin, M. M.; Kharitonova, E. P.; Gallyamov, M. O.; Khokhlov, A. R. Chemical Recycling ofPolyethylene in Oxygen-Enriched Supercritical CO₂. J Supercrit Fluids 2022, 181, 105503. https://doi.org/10.1016/J.SUPFLU.2021.105503.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A method of synthesizing a wax or a polyketone, comprising;
reacting of a polyolefin with a peroxide in a presence of a solvent under conditions including a temperature below 200° C., wherein at least one of carbon-carbon bonds or carbon-hydrogen bonds in the polyolefin are cleaved via oxidation by the peroxide so as to form a polyketone or a wax comprising an oxidized polyolefin.

2. The method of claim 1, further comprising catalyzing the reaction using a catalyst decomposing the peroxide so that oxygen from the peroxide can react more readily with the polyolefin.

3. The method of claim 1, further comprising catalyzing the reaction using [Fe(III)SO₄] or MnBr₂.

4. The method of claim 2, wherein the peroxide is hydrogen peroxide, the solvent is water, and the reaction forms the polyketone.

5. The method of claim 2, wherein the peroxide is TBHP, the solvent is water, and the reaction forms the wax.

6. The method of claim 5, wherein wax has a molecular weight of 500 or less or 1000 or less.

7. The method of claim 1, further comprising controlling at least one of a composition of the peroxide, the temperature, and a duration of the reaction to select the wax or the polyketone.

8. The method of claim 1, wherein the peroxide comprises a hydroperoxide and the polyolefin comprises at least one of polyethylene, polystyrene, or polypropylene.

9. The method of claim 1, further comprising selecting a weight percentage of the peroxide in the solution relative to a mass of the polyolefin so as to achieve a desired molecular weight of the oxidized polyolefin, wherein a lesser weight percentage of the peroxide results in a higher molecular weight of the oxidized polyolefin.

10. The method of claim 1, comprising:
10 wt %-200 wt % of the peroxide in the solution, relative to a mass of the polyolefin in the solution, or
contacting the peroxide with the polyolefin with a mole ratio, comprising a number of moles of the monomer unit (in the polyolefin) divided by the number of moles of the peroxide, in a range from ca. 0.5 to ca. 20.

11. The method of claim 10, wherein the solvent comprises any hydrocarbon-based solvent capable of at least partially dissolving the polyolefin.

12. The method of claim 1, wherein the peroxide comprises a hydroperoxide, the solvent comprises water, and the polyolefin comprises polyethylene.

13. The method of claim 1, wherein the oxidized polyolefin comprises a carbonyl or a ketone oxygen content greater than its ester and a carboxylic acid oxygen content.

14. (canceled)

15. The method of claim 1, wherein an amount of the peroxide and a reaction time of the reaction are selected so that the one or more waxes have a number average molecular weight (Mₙ) in a range of 500-5000 g/mol with a dispersity in a range of 1.2-2.5.

16. The method of claim 15, wherein the temperature is above 100° C. and below 200° C.

17. (canceled)

18. The method of claim 1, further comprising contacting untreated plastic waste, comprising at least the polyolefin with the solvent.

19. A composition of matter, comprising an oxidized polyolefin having at least one of:
a number-averaged molecular weight in a range of 500-5000 g/mol and optionally a dispersity index in a range of 1.2 to 2.5;
an oxygen content characterized by a saponification number in a range of 30-200 (30≤saponification number≤200) or 30-150 (30≤saponification number≤150), wherein the saponification is the amount of potassium hydroxide in milligrams required to saponify one gram of the oxidized polyolefin,
the oxygen content characterized by an acid number in a range of 15-100, wherein the acid number is the amount of potassium hydroxide in milligrams required to neutralize 1 g of oxidized polyolefin dissolved in xylene,
an oxygen content of 3-15 wt. % (e.g., 3 wt. %≤oxygen content≤15 wt %) relative to the mass of the oxidized polyolefin,
a ketone oxygen content, which is greater than the ester and carboxylic acid oxygen content; or
an alcohol oxygen content, which is ca. 1-4 wt %.

20. (canceled)

21. The composition of matter of claim 19, wherein the oxidized polyolefin is characterized by the saponification number comparable to or greater than that for the oxidized polyolefin formed by oxidation of a molten polyolefin by melt oxidation, oxidation of the polyolefin in an aqueous dispersion, or oxidation of the polyolefin in a solid form.

22. (canceled)

23. (canceled)

24. The composition of matter of claim 19, wherein the oxidized polyolefin comprises the structure:

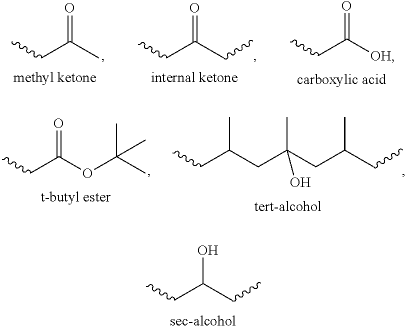

25. (canceled)

26. (canceled)

27. (canceled)

28. A polyketone comprising an oxygen content larger than 4 wt %; wherein a content of ketones is greater than a content of the esters and the polyketone has the structure:

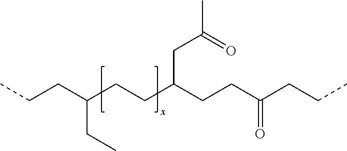

29.-35. (canceled)
